(19) United States
(12) Patent Application Publication
(10) Pub. No.: US 2026/0169159 A1
(43) Pub. Date: Jun. 18, 2026

(54) OBJECT DETECTION DEVICE

(71) Applicant: DENSO CORPORATION, Kariya-city (JP)

(72) Inventors: Shogo NAKAMURA, Nisshin-city (JP); Yu KOYAMA, Nisshin-city (JP); Takuya NOMURA, Kariya-city (JP)

(21) Appl. No.: 19/529,996

(22) Filed: Feb. 4, 2026

Related U.S. Application Data
(63) Continuation of application No. PCT/JP2024/025396, filed on Jul. 15, 2024.

(30) Foreign Application Priority Data
Aug. 9, 2023 (JP) 2023-130236

(51) Int. Cl. G01S 15/04; G01S 7/52; G01S 7/536; G01S 15/86

(52) U.S. Cl. CPC G01S 15/04; G01S 7/52015; G01S 7/536; G01S 15/86

(57) ABSTRACT

An object detection device includes a plurality of transducers including a first transducer and a second transducer, each configured to transmit an ultrasonic search wave distinguishable from the other, and an incoming signal processor. At least one of the transducers is reception-capable and receives reflected waves produced by reflection of the transmitted search waves from surrounding objects. The incoming signal processor distinguishes, from a reflected-wave signal received by the reception-capable transducer, a first incoming signal corresponding to a reflected wave of the search wave transmitted by the first transducer and a second incoming signal corresponding to a reflected wave of the search wave transmitted by the second transducer. The incoming signal processor performs first signal processing on the first incoming signal under a first prescribed condition and performs second signal processing on the second incoming signal under a second prescribed condition different from the first condition.

### CROSS-REFERENCE TO RELATED APPLICATION

This application is a continuation application of International Application No. PCT/JP2024/025396 filed Jul. 15, 2024 which designated the U.S. and claims priority to Japanese Patent Application No. 2023-130236 filed on Aug. 9, 2023, the contents of each of which are incorporated herein by reference.

### BACKGROUND

### Technical Field

The present disclosure relates to an object detection device that detects an object.

### Related Art

A conventionally known object detection device includes a plurality of ultrasonic sensors including transducers that transmit search waves, which are ultrasonic waves, and receive reflected waves produced by reflection of the search waves. Therefore, each transducer receives a plurality of reflected waves originating from different transmission sources.

The transducers transmit ultrasonic waves accompanying codes enabling identification of the transmission sources of the ultrasonic waves, and therefore, the ultrasonic sensors that receive a plurality reflected waves originating from different transmission sources can distinguish the reflected waves from each other by the codes.

### BRIEF DESCRIPTION OF THE DRAWINGS

In the accompanying drawings:

FIG. 1 is a block diagram illustrating a schematic configuration of an object detection device according to a first embodiment;

FIG. 2 is a diagram schematically illustrating transmitting/receiving operations of a plurality of transducers included in the object detection device in the first embodiment;

FIG. 3 is a block diagram illustrating a functional configuration of an incoming signal processor included in an ultrasonic sensor of the object detection device in the first embodiment;

FIG. 4 is a flowchart illustrating control processing executed by the incoming signal processor in the first embodiment;

FIG. 5 is a graph illustrating one example of an amplitude signal generated from an incoming signal in step S02 of FIG. 4;

FIG. 6 is a graph illustrating an amplitude feature extracted from the amplitude signal in FIG. 5 together with the amplitude signal in FIG. 5.

FIG. 7 is a partially enlarged graph obtained by enlarging portion VII in FIG. 6, the graph showing a reflected-wave threshold value in the first embodiment;

FIG. 8 is a graph for explaining STC processing and threshold-value-based processing included in signal processing executed in steps S051, S052 of FIG. 4 in the first embodiment;

FIG. 9, which corresponds to FIG. 8, is a graph for explaining non-identification STC processing and non-identification threshold-value-based processing executed in step S07 of FIG. 4 in the first embodiment;

FIG. 10 is a flowchart illustrating control processing executed by a detection determination section of FIG. 3 in the first embodiment;

FIG. 11 is graphs illustrating examples of the state of signal processing based on which a point to be accumulated is determined in step S202 of FIG. 10;

FIG. 12 is a chart illustrating the points that are to be accumulated and have been determined according to the states of the signal processing in FIG. 11;

FIG. 13, which corresponds to FIG. 8, is a graph for explaining STC processing and threshold-value-based processing executed in a comparative example to be compared with the first embodiment;

FIG. 14, which corresponds to FIG. 1, is a block diagram illustrating a schematic configuration of an object detection device according to a second embodiment;

FIG. 15, which corresponds to FIG. 7, is a partially enlarged graph obtained by enlarging a portion corresponding to portion VII in FIG. 6, the graph showing a reflected-wave threshold value in a third embodiment;

FIG. 16 is a graph schematically illustrating a relationship between a reflected-wave threshold value, a road-surface reflection amplitude signal, a first road-surface reflection amplitude signal, a second road-surface reflection amplitude signal, and a delay time used in step S03 of FIG. 4 in a fourth embodiment;

FIG. 17 is a graph illustrating a first threshold value and a second threshold value that vary based on the delay time in the fourth embodiment;

FIG. 18, which corresponds to FIG. 1, is a block diagram illustrating a schematic configuration of an object detection device according to a fifth embodiment;

FIG. 19, which corresponds to FIG. 4, is a flowchart illustrating control processing executed by an incoming signal processor in the fifth embodiment;

FIG. 20 is a graph schematically illustrating a relationship between a road-surface reflection amplitude signal obtained when the road-surface roughness of a road surface captured by a camera is a first road-surface roughness, and a reflected-wave threshold value determined based on the first road-surface roughness in the fifth embodiment;

FIG. 21 is a graph schematically illustrating a relationship between a road-surface reflection amplitude signal obtained when the road-surface roughness of a road surface captured by a camera is a second road-surface roughness smoother than the first road-surface roughness, and a reflected-wave threshold value determined based on the second road-surface roughness in the fifth embodiment;

FIG. 22, which corresponds to FIG. 17, is a graph illustrating a first threshold value and a second threshold value changed based on the road-surface roughness as an external environment in the surroundings of the own vehicle in the fifth embodiment; and

FIG. 23 is a block diagram illustrating a plurality of ultrasonic sensors extracted from a schematic configuration of an object detection device according to another embodiment.

### DESCRIPTION OF SPECIFIC EMBODIMENTS

The known object detection device, as disclosed in WO 2020/261894 A, includes a plurality of transducers, and therefore, each of the transducers receives a plurality of reflected waves originating from different transmission sources. In this object detection device, signal processing is performed on distinguished individual incoming signals, corresponding to reflected waves that have been received and originating from different transmission sources, under a common signal processing condition.

However, when the transmission sources of the received reflected waves are different, the propagation pathway and the propagation time of the reflected waves and the search waves based on which the reflected waves are produced are different. Therefore, in order to appropriately perform the signal processing on the plurality of incoming signals originating from different transmission sources, the signal processing conditions used for the signal processing are desired to be different from each other.

That is, it is presumed that when performed on the plurality of incoming signals, which have been distinguished according to the transmission sources thereof, under a common signal processing condition regardless of the transmission sources, the signal processing cannot be appropriately performed on each of the plurality of incoming signals. The matters described above have been found as a result of detailed study by the inventors.

In view of the foregoing, it is desired to have an object of the present disclosure is to provide an object detection device including a plurality of transducers, the object detection device enabling appropriate signal processing for each of a plurality of incoming signals that correspond to reflected waves and have been distinguished.

One aspect of the present disclosure provides an object detection device for detecting a surrounding object, including:
a plurality of transducers that include a first transducer and a second transducer each transmitting a search wave that is an ultrasonic wave distinguishable from one another; and
an incoming signal processor, wherein
at least any one of the plurality of transducers including the first transducer and the second transducer is a reception-capable transducer that receives a reflected wave produced by reflection of the search wave from the object, and
from a reflected-wave signal corresponding to the reflected wave received by the reception-capable transducer, the incoming signal processor distinguishes a first incoming signal corresponding to a reflected wave of the search wave transmitted by the first transducer and a second incoming signal corresponding to a reflected wave of the search wave transmitted by the second transducer, and performs first signal processing, which is signal processing for the first incoming signal, under a prescribed first condition and performs second signal processing, which is signal processing for the second incoming signal, under a prescribed second condition different from the first condition.

In this configuration, the first condition, which is a signal processing condition for performing the first signal processing, and the second condition, which is a signal processing condition for performing the second signal processing, need not be standardized and can be set separately. Therefore, it is possible to appropriately perform the first signal processing on the first incoming signal under the first condition, and appropriately perform the second signal processing on the second incoming signal under the second condition.

In the sections of the application document, each element sometimes has a parenthesized reference sign assigned thereto. In this case, the reference sign only represents one simple example of a corresponding relationship between the element and a specific configuration in the embodiments described later. Accordingly, the present disclosure is not to be limited at all by the description of the reference signs.

Hereinafter, embodiments are described with reference to the drawings. Mutually identical or equivalent parts among the following embodiments share identical reference signs in the drawings.

### First Embodiment

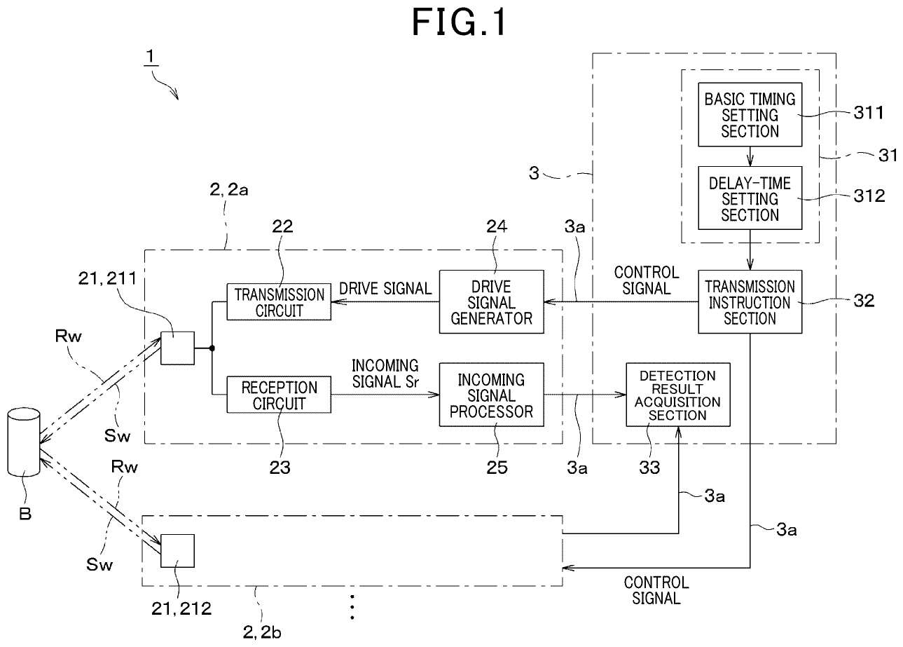

An object detection device 1 illustrated in FIG. 1 is mounted in a vehicle (not illustrated), and is configured to detect an object B in the surroundings of the vehicle. The vehicle having the object detection device 1 mounted therein is hereinafter called the “own vehicle”. The vehicle (not illustrated) is, for example, an automobile.

The object detection device 1 includes a plurality of ultrasonic sensors 2 and a controller 3 that controls an operation of each of the plurality of ultrasonic sensors 2. Each of the plurality of ultrasonic sensors 2 is configured to detect the object B by transmitting a search wave Sw that is an ultrasonic wave, and receives, as an incoming wave Rw, a reflected wave produced by reflection of the search wave Sw from the object B. For example, another vehicle or a building present in the surroundings of the own vehicle may be considered as the object B.

The ultrasonic sensors 2 each include a transducer 21, a transmission circuit 22, a reception circuit 23, a drive signal generator 24, and an incoming signal processor 25.

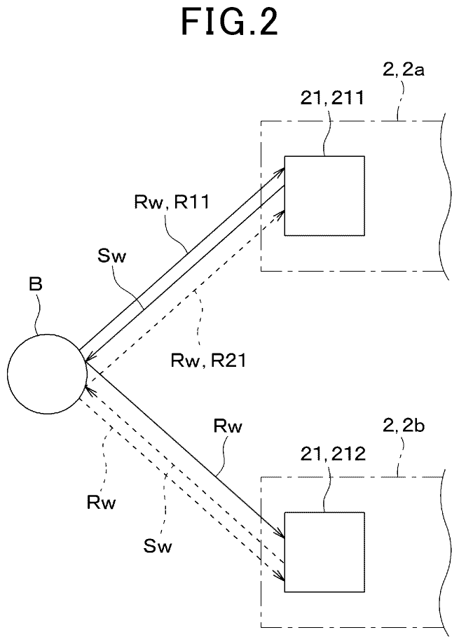

As illustrated in FIGS. 1 and 2, the transducer 21 transmits the search wave Sw, and receives, as the incoming wave Rw, a reflected wave produced by reflection of the search wave Sw from the object B. For example, in the present embodiment, all the transducers 21 including a first transducer 211 and a second transducer 212 described later are transmission-capable transducers that transmit the search waves Sw, and are also reception-capable transducers that receive reflected waves produced by reflection of the search waves Sw from the object B. In other words, all the plurality of transducers 21 included in the object detection device 1 have a function of a transmitter that transmits the search wave Sw to the exterior, and a function of a receiver that receives the incoming wave Rw.

The transducer 21 is electrically connected to the transmission circuit 22 and the reception circuit 23. For example, the transducer 21 may have a transceiver integrated configuration.

Specifically, the transducer 21 is configured as an ultrasonic microphone incorporating an electric-mechanical energy transducer element such as a piezoelectric element. The transducer 21 is disposed at a position facing the outer surface of the own vehicle so as to be able to transmit the search wave Sw to the exterior of the own vehicle and receive the reflected wave from the exterior of the own vehicle.

In the description of the present embodiment, one of the plurality of ultrasonic sensors 2 is sometimes called a first ultrasonic sensor 2a, and another one is sometimes called a second ultrasonic sensor 2b. In addition, the transducer 21 included in the first ultrasonic sensor 2a is sometimes called a first transducer 211, and the transducer 21 included in the second ultrasonic sensor 2b is sometimes called a second transducer 212.

In FIG. 2, the search wave Sw transmitted from the first transducer 211 and the incoming wave Rw generated by reflection of the search wave Sw are respectively shown by solid arrows. Also in FIG. 2, the search wave Sw transmitted from the second transducer 212 and the incoming wave Rw generated by reflection of the search wave Sw are respectively shown by dashed arrows.

The transmission circuit 22 illustrated in FIG. 1 is provided so as to cause the transducer 21 to emit the search wave Sw by driving the transducer 21 on the basis of a drive signal input. Specifically, the transmission circuit 22 includes a digital/analog conversion circuit and the like. That is, the transmission circuit 22 is configured to generate an element input signal by performing signal processing such as digital/analog conversion on a drive signal output from the drive signal generator 24. The element input signal is an AC voltage signal for driving the transducer 21. The transmission circuit 22 is configured to cause the transducer 21 to generate the search wave Sw by applying the generated element input signal to the transducer 21 and thus exciting the electric-mechanical energy transducer element in the transducer 21.

The reception circuit 23 is provided so as to generate an incoming signal Sr corresponding to a result of the incoming wave Rw received by the transducer 21, and output the incoming signal Sr to the incoming signal processor 25. Specifically, the reception circuit 23 includes an amplifier circuit, an analog/digital conversion circuit, and the like. That is, the reception circuit 23 is configured to generate the incoming signal Sr containing information on the amplitude and the frequency of the incoming wave Rw by performing signal processing such as amplification and analog/digital conversion on an element output signal output by the transducer 21. The element output signal is an AC voltage signal that the electric-mechanical energy transducer element provided in the transducer 21 generates upon receiving the incoming wave Rw.

The incoming wave Rw received by the transducer 21 is specifically a reflected wave generated by reflection of the search wave Sw. Accordingly, the incoming signal Sr output from the reception circuit 23 can also be said to be a reflected-wave signal corresponding to the reflected wave received by the transducer 21 as the reception-capable transducer.

The drive signal generator 24 is provided so as to generate a drive signal and output the drive signal to the transmission circuit 22. The drive signal is a signal for driving the transducer 21 and causing the transducer 21 to emit the search wave Sw. For example, the drive signal generator 24 is configured to include one or both of an electric circuit that performs signal processing and a microcomputer that performs signal processing by executing a prescribed program.

The plurality of ultrasonic sensors 2 are provided so that the search waves Sw thereof have different features distinguishable from one another. That is, the drive signal generator 24 is configured to generate a drive signal that assigns the search wave Sw a transmission-source-distinguishable feature. Specifically, in the present embodiment, the search wave Sw has a prescribed frequency modulation state, and the drive signal generator 24 generates a drive signal corresponding to the frequency modulation state.

Examples of the prescribed frequency modulation state include an up-chirp and a down-chirp. The up-chirp is a frequency modulation state in which the frequency increases monotonically with the lapse of time. The down-chirp is a frequency modulation state in which the frequency decreases monotonically with the lapse of time. Specifically, for example, the drive signal generator 24 is configured to be capable of assigning the search wave Sw a multi-bit code obtained by combining an up-chirp signal corresponding to the code “01”, a down-chirp signal corresponding to the code “10”, and a CW signal corresponding to the code “11”. The CW signal is a signal having a constant frequency that does not vary with the lapse of time. CW is an abbreviation for continuous waveform. The “constant frequency” state corresponding to the CW signal is also included in the “frequency modulation states”. The CW signal is also called the CF signal. CF is an abbreviation for continuous frequency.

The drive signal generators 24 respectively included in the plurality of ultrasonic sensors 2 are provided so as to generate and output drive signals respectively corresponding to different encoding states. Specifically, for example, the drive signal generator 24 in one ultrasonic sensor 2 generates a drive signal corresponding to a 3-bit code of “01, 10, 11”. On the other hand, the drive signal generator 24 in another ultrasonic sensor 2 generates a drive signal corresponding to a 3-bit code of “10, 01, 11”.

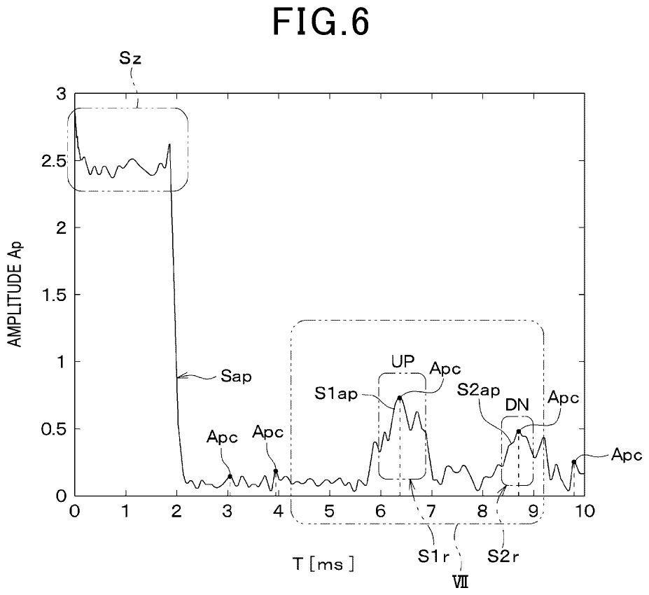

In the following drawings, however, the codes are not shown as “10, 01, 11” and the like described above, but are abbreviated as “UP” and “DN” as shown in, for example, following FIG. 6. Specifically, in, for example, following FIG. 6, “UP” in the chart means that the transmission source of the search wave Sw is the first transducer 211, and “DN” means that the transmission source of the search wave Sw is the second transducer 212. The object detection device 1 includes many ultrasonic sensors 2, but, in the following description, the ultrasonic sensors 2 other than the first and second ultrasonic sensors 2a, 2b are not always mentioned, for simplicity.

The incoming signal processor 25 illustrated in FIG. 1 is configured to include one or both of an electric circuit that performs signal processing and a microcomputer that performs signal processing by executing a prescribed program. Thereby, the incoming signal processor 25 performs signal processing on the incoming signal Sr obtained from the reception circuit 23, and outputs a result of the signal processing to the controller 3. The signal processing performed by the incoming signal processor 25 is described later in detail.

The controller 3 is connected to the plurality of ultrasonic sensors 2 for telecommunications via a communication bus 3a that is an in-vehicle communication line. The controller 3 is configured to control transmitting/receiving operations of each of the plurality of ultrasonic sensors 2. The communication bus 3a forms a communication pathway connecting the controller 3 to each of the plurality of ultrasonic sensors 2.

The controller 3 is provided as a so-called sonar ECU. The controller 3 has a configuration of a microcomputer including a CPU, a RAM, a ROM, a non-volatile rewritable memory, etc. (not shown). That is, the controller 3 reads a computer program stored in a ROM or non-volatile rewritable memory that is a non-transitory tangible recording medium, and executes the program. By the execution of the computer program, a method corresponding to the computer program is executed. That is, the controller 3 executes various kinds of control processing according to the computer program.

The ECU is an abbreviation for Electronic Control Unit. Examples of the non-volatile rewritable memory include an EEPROM and a flash ROM. EEPROM is an abbreviation for Electronically Erasable and Programmable Read Only Memory. The microcomputers of the drive signal generator 24 and the incoming signal processor 25 also have the same configuration as the microcomputer of the controller 3.

The controller 3 includes a transmission timing setting section 31, a transmission instruction section 32, and a detection result acquisition section 33 as functional configurations implemented by the microcomputer.

The transmission timing setting section 31 is provided so as to set a transmission timing of the search wave Sw for each of the plurality of ultrasonic sensors 2. In the present embodiment, the transmission timing setting section 31 is configured to set a delay time ΔT on the basis of the mutual positional relationship between the plurality of ultrasonic sensors 2 so that the plurality of ultrasonic sensors 2 transmit the search waves Sw with mutually different transmission timings. Specifically, the transmission timing setting section 31 includes a basic timing setting section 311 and a delay-time setting section 312.

The basic timing setting section 311 is provided so as to set a basic timing for each of the plurality of ultrasonic sensors 2. The basic timing is a transmission timing set at each of the plurality of ultrasonic sensors 2 to come in a mutually identical cycle among the ultrasonic sensors 2. That is, the basic timing is a transmission timing that has not been corrected by the delay-time setting section 312.

The delay-time setting section 312 is provided so as to set the delay time ΔT, by which the transmission timing coming in a prescribed cycle is temporally shifted from the basic timing, for each of the plurality of ultrasonic sensors 2. That is, the delay-time setting section 312 is configured to set the delay time ΔT with respect to the basic timing on the basis of the mutual positional relationship between the plurality of ultrasonic sensors 2. Specifically, the delay-time setting section 312 delays the transmission timing of the search wave Sw from the basic timing by the delay time ΔT for an ultrasonic sensor 2 different from an ultrasonic sensor 2 emitting the search wave Sw in a constant cycle with the basic timing.

In the present embodiment, the first transducer 211 transmits the search wave Sw with the basic timing without delay. Following the first transducer 211, the second transducer 212 transmits the search wave Sw, and thereafter, transducers 21 other than the first and second transducers 211, 212 sequentially transmit the search waves Sw. The first and second transducers 211, 212 are described as examples. After the lapse of the delay time ΔT from the moment when the first transducer 211 has started the transmission of the search wave Sw, the second transducer 212 starts the transmission of the search wave Sw.

The transmission instruction section 32 is provided so as to instruct each of the plurality of ultrasonic sensors 2 to start the operation of transmitting the search wave Sw on the basis of the transmission timing set by the transmission timing setting section 31. Specifically, the transmission instruction section 32 transmits a control signal to an ultrasonic sensor 2 whose transmission timing has come, and thereby causes the ultrasonic sensor 2 to start the operation of transmitting the search wave Sw.

Thus, the transmission/reception processing including the transmission of the search waves Sw and the reception of the incoming waves Rw, which are reflected waves, is repeated by the plurality of transducers 21 over time.

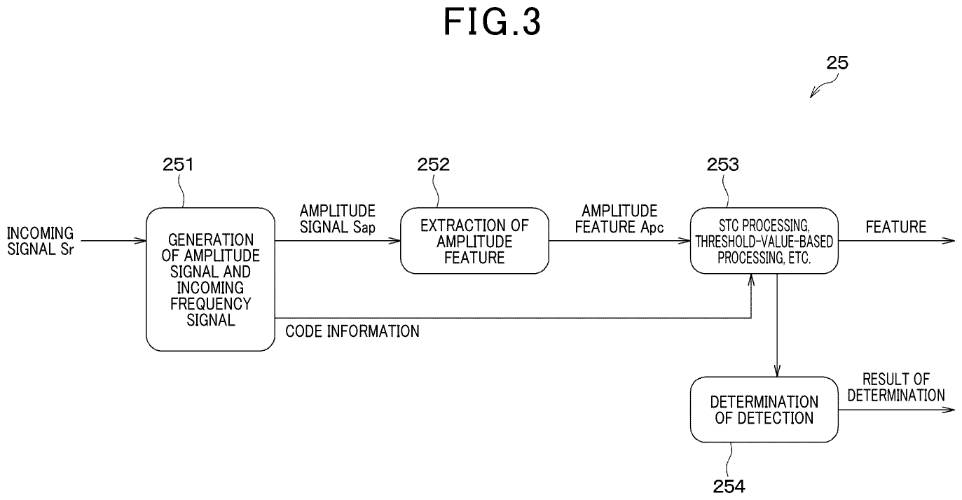

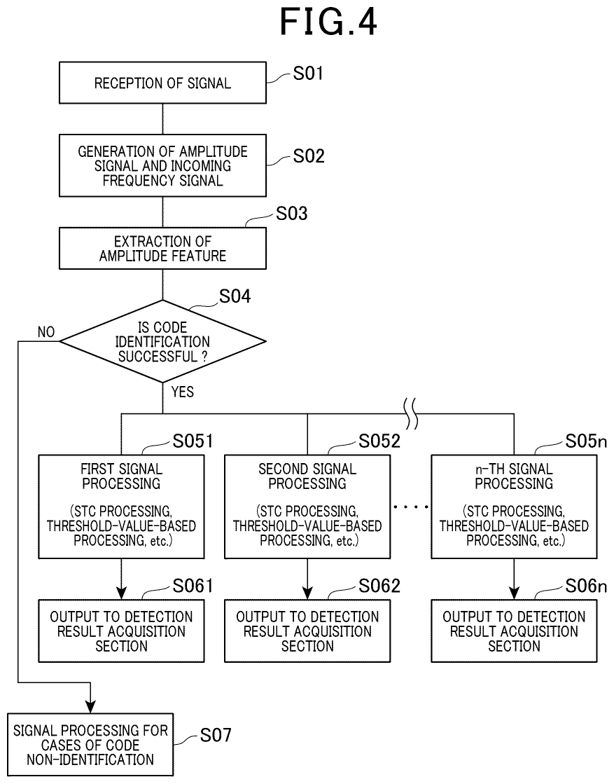

The incoming signal processor 25 performs signal processing on the incoming signal Sr as described above. For the signal processing, the incoming signal processor 25 includes a signal converter 251, a feature extractor 252, a determination processing section 253, and a detection determination section 254, as illustrated in FIG. 3. The incoming signal processor 25 carries out the signal processing on the incoming signal Sr according to the flowchart of FIG. 4. The flowchart of FIG. 4 is periodically repeated.

Here, “n” in FIG. 4 represents the number of the ultrasonic sensors 2 included in the object detection device 1. In the present embodiment, the processing performed by the signal converter 251 and the feature extractor 252 is implemented by hardware processing using, for example, an electric control circuit. On the other hand, the processing performed by the determination processing section 253 and the detection determination section 254 is implemented by software processing performed according to, for example, a computer program.

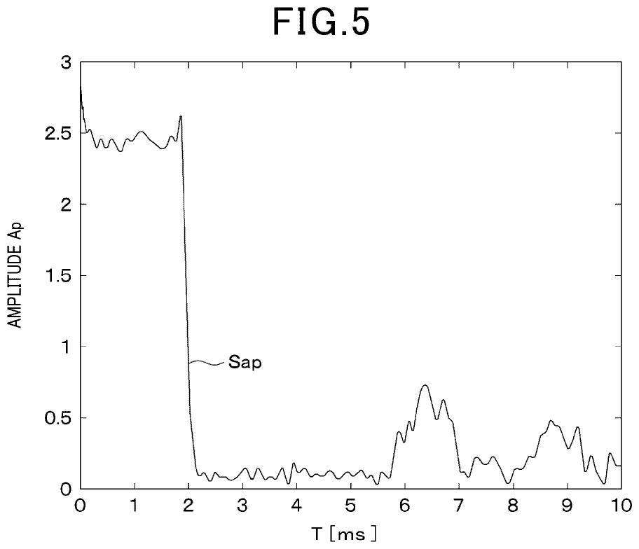

First, in step S01 of FIG. 4, the signal converter 251 receives the incoming signal Sr from the reception circuit 23. In following step S02, the signal converter 251 is configured to generate an amplitude signal Sap and an incoming frequency signal by performing processing such as FFT on the incoming signal Sr. FFT is an abbreviation for Fast Fourier Transform. The amplitude signal Sap is a signal representing an amplitude Ap of the incoming signal Sr, that is, a signal corresponding to the amplitude of the incoming wave Rw. FIG. 5 illustrates one example of the amplitude signal Sap.

As illustrated in FIG. 5, the amplitude signal Sap represents a relationship between a lapse time T from a predetermined moment and the amplitude Ap of the incoming signal Sr. In the present embodiment, the predetermined moment “lapse time T=0” is regarded as, for example, the moment when, among the plurality of transducers 21 that continuously transmit the search waves Sw with shifted transmission timings, a transducer 21 that is to first transmit the search wave Sw has started the transmission of the search wave Sw. That is, in the present embodiment, the first transducer 211 transmits the search wave Sw with the basic timing as described above, and therefore, the predetermined moment is regarded as the moment when the first transducer 211 has started the transmission of the search wave Sw.

The incoming frequency signal is a frequency signal of the incoming wave Rw, that is, a signal corresponding to incoming frequency. In other words, the incoming frequency signal is a signal corresponding to the encoding state of the incoming signal Sr. Accordingly, the incoming frequency signal functions as code information that enables the transmission source of the search wave Sw to be distinguished. The signal converter 251 outputs the amplitude signal Sap and incoming frequency signal generated.

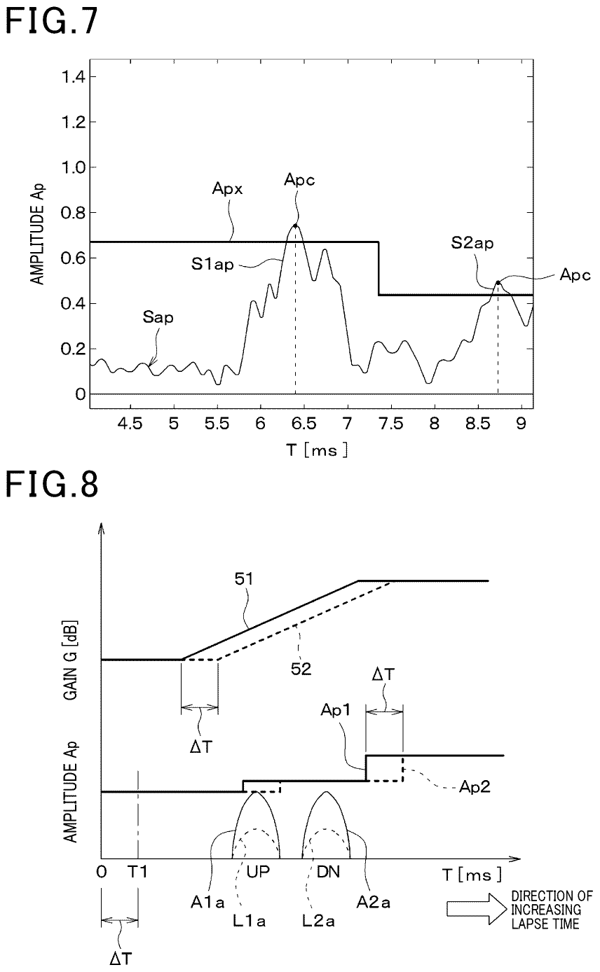

In step S03 of FIG. 4, the feature extractor 252 receives the amplitude signal Sap from the signal converter 251. Then, as illustrated in FIGS. 6 and 7, the feature extractor 252 extracts, from the amplitude signal Sap, an amplitude feature Apc that is a feature of the amplitude Ap of the incoming signal Sr. For example, the feature extractor 252 extracts, as the amplitude feature Apc, a portion, in which a local maximum of the amplitude Ap of the incoming signal Sr exceeds a prescribed reflected-wave threshold value Apx, from the amplitude signal Sap. In other words, the feature extractor 252 extracts, as the amplitude feature Apc, one or a plurality of local maximum points, at which the amplitude Ap of the incoming signal Sr exceeds the reflected-wave threshold value Apx and forms local maxima, from among the amplitude signal Sap. The amplitude feature Apc represents the lapse time T on the horizontal axis and the amplitude Ap of the incoming signal Sr on the vertical axis in FIG. 6.

As illustrated in FIG. 7, the reflected-wave threshold value Apx is a static threshold value because it varies based on the lapse time T but the relationship between the reflected-wave threshold value Apx and the lapse time T is fixed regardless of the waveform of the amplitude signal Sap. A reflected-wave-threshold-value-related line, which represents the relationship between the reflected-wave threshold value Apx and the lapse time T is, for example, preliminarily set for the amplitude signal Sap through experiments so as to reduce the right amount of data on the amplitude feature Apc. The feature extractor 252 outputs the amplitude feature Apc extracted.

A portion Sz of the amplitude signal Sap in FIG. 6 is a portion corresponding to reverberation generated by the act of transmission by the transducer 21, and therefore, the extraction of the amplitude feature Apc is performed without the Sz portion.

In S04 of FIG. 4, on the basis of the incoming frequency signal obtained from the signal converter 251, the determination processing section 253 identifies a code contained in the incoming wave Rw corresponding to the incoming frequency signal. Thereby, the determination processing section 253 distinguishes between a plurality of incoming signals based on the reflected waves of the search waves Sw from mutually different transmission sources, i.e., the transducers 21, according to the transmission sources of the search waves Sw.

In example cases of the first and second transducers 211, 212 among the plurality of transmission sources of the search wave Sw, the following can be said. That is, the determination processing section 253 distinguishes between a first incoming signal S1r corresponding to the reflected wave of the search wave Sw transmitted by the first transducer 211 and a second incoming signal S2r corresponding to the reflected wave of the search wave Sw transmitted by the second transducer 212. The first and second incoming signals S1r, S2r are contained in the incoming signals Sr generated and output by the reception circuits 23.

FIG. 6 illustrates, as one example, a first amplitude signal S1ap representing the amplitude Ap of the first incoming signal S1r and a second amplitude signal S2ap representing the amplitude Ap of the second incoming signal S2r. As illustrated in FIG. 6, distinguishing between the first incoming signal S1r and the second incoming signal S2r is distinguishing the first amplitude signal S1ap and the second amplitude signal S2ap from the amplitude signal Sap.

When the code identification in step S04 of FIG. 4 has been successful, in other words, when the plurality of incoming signals originating from different transmission sources have been able to be distinguished from one another, the process in FIG. 4 proceeds to respective steps S051 to S05n. The plurality of incoming signals originating from different transmission sources are, for example, the first incoming signal S1r and the second incoming signal S2r. Then, steps S051 to S05n proceed in parallel.

For example, in step S051, the determination processing section 253 performs first signal processing, which is signal processing for the first incoming signal S1r, under a prescribed first condition. The first signal processing is signal processing for the first incoming signal S1r based on the search wave Sw transmitted from the first transducer 211. The first signal processing, and signal processing in steps S052 to S05n described later are performed to determine the detection of the object B on the basis of the incoming signal Sr.

Specifically, in the first signal processing, the determination processing section 253 executes first STC processing for correcting the first incoming signal S1r by a first STC 51 as illustrated in FIG. 8. In detail, in the first STC processing, the determination processing section 253 amplifies by the first STC 51 the amplitude feature Apc corresponding to the first incoming signal S1r from among all amplitude features Apc extracted by the feature extractor 252. Further, in the first signal processing, the determination processing section 253 also executes first-threshold-value-based processing for determining whether a post-correction amplitude A1a of the first incoming signal S1r obtained through the correction by the first STC 51 is higher than or equal to a prescribed first threshold value Ap1.

In this processing, the post-correction amplitude A1a of the first incoming signal S1r, which is the subject of determination, is more specifically an amplitude obtained by correcting the amplitude feature Apc corresponding to the first incoming signal S1r by the first STC 51. Accordingly, the subject to be determined whether it is higher than or equal to the first threshold value Ap1 is more specifically an amplitude feature Apc from the post-correction amplitude A1a of the first incoming signal S1r.

In the cases in which there are a plurality of amplitude features Apc of the post-correction amplitude A1a that are the subjects of determination, when at least any one of the plurality of amplitude features Apc of the post-correction amplitude A1a is higher than or equal to the first threshold value Ap1, the post-correction amplitude A1a is determined to be higher than or equal to the first threshold value Ap1. The same applies to the threshold-value-based processing performed after the other STC processing described later.

In the present embodiment, one determination that the post-correction amplitude A1a of the first incoming signal S1r is higher than or equal to the first threshold value Ap1 does not immediately lead to the determination that the object B has been detected, but acts on affirming that the object B has been detected on the basis of the first incoming signal S1r.

STC is an abbreviation for Sensitivity Time Control. As illustrated in FIG. 8, in the first STC 51, a gain G is determined based on the lapse time T. In detail, the gain G of the first STC 51 varies based on the lapse time T within a predetermined period of the lapse time T, and increases in the direction of increasing the lapse time T. The same applies to the STCs (for example, a second STC 52 described later) used in the STC processing, other than the first STC processing, described later.

The first threshold value Ap1 is a threshold value that varies based on the lapse time T, and is preliminarily set through experiments so that the detection of the object B can be appropriately determined without erroneous determination caused by noise or the like. The same applies to the threshold values of the threshold-value-based processing in steps S052 to S05n described later.

The first threshold value Ap1 is a static threshold value with a fixed relationship between the first threshold value Ap1 and the lapse time T, and the threshold values of the threshold-value-based processing in steps S052 to S05n described later are also static threshold values with the relationship between the threshold value and the lapse time T fixed as long as the delay time ΔT is not varied.

Here, a dashed line L1a in FIG. 8 represents a pre-correction amplitude of the first incoming signal S1r that has not been corrected by the first STC processing, more specifically an amplitude feature Apc of the pre-correction amplitude. In an example of FIG. 8, as is understandable from the relationship between the post-correction amplitude A1a of the first incoming signal S1r and the first threshold value Ap1, the post-correction amplitude A1a of the first incoming signal S1r is determined to be lower than the first threshold value Ap1.

As described above, the first signal processing includes the first STC processing and the first-threshold-value-based processing, and in the first signal processing, the first STC processing and the first-threshold-value-based processing are sequentially executed. Therefore, the first condition employed in the first signal processing consists of the first STC 51 and the first threshold value Ap1. The determination processing section 253 does not perform the first signal processing using the amplitude signal Sap itself, but performs the first signal processing using the amplitude feature Apc extracted from the amplitude signal Sap.

After completion of the first signal processing, the determination processing section 253 transmits a processing result of the first signal processing and a feature of the first incoming signal S1r to the communication bus 3a in step S061 of FIG. 4. Then, the processing result of the first signal processing and the feature of the first incoming signal S1r transmitted to the communication bus 3a are input from the communication bus 3a to the detection result acquisition section 33 of the controller 3.

The processing result of the first signal processing is a determination result of the first-threshold-value-based processing. The feature of the first incoming signal S1r consists of, for example, the amplitude feature Apc from the post-correction amplitude A1a of the first incoming signal S1r, the code representing the transmission source corresponding to the first incoming signal S1r, and TOF of the first incoming signal S1r. TOF is an abbreviation for Time of Flight. The processing result of the first signal processing is also output to the detection determination section 254.

The processing contents of steps S052 to S05n in FIG. 4 are the same as in step S051 described above, and the determination processing sections 253 perform the same signal processing as in step S051 in steps S052 to S05n respectively according to the codes representing the transmission sources of the search waves Sw. The processing contents of steps S062 to S06n are the same as in step S061 described above. However, the STCs and the threshold values employed in the signal processing in steps S051 to S05n are based on the transmission sources of the search waves Sw, and are therefore different from each other among steps S051 to S05n.

For example, steps S052 and S062 are described. First, in step S052, the determination processing section 253 performs second signal processing, which is signal processing for the second incoming signal S2r, under a prescribed second condition, which is different from the first condition in step S051.

Specifically, in the second signal processing, the determination processing section 253 executes second STC processing for correcting the second incoming signal S2r by a second STC 52 as illustrated in FIG. 8. In detail, in the second STC processing, the determination processing section 253 amplifies by the second STC 52 an amplitude feature Apc corresponding to the second incoming signal S2r from among all amplitude features Apc extracted by the feature extractor 252. Further, in the second signal processing, the determination processing section 253 also executes second-threshold-value-based processing for determining whether a post-correction amplitude A2a of the second incoming signal S2r obtained through the correction by the second STC 52 is higher than or equal to a prescribed second threshold value Ap2.

In this processing, the post-correction amplitude A2a of the second incoming signal S2r, which is the subject of determination, is more specifically an amplitude obtained by correcting the amplitude feature Apc corresponding to the second incoming signal S2r by the second STC 52. Accordingly, the subject to be determined whether it is higher than or equal to the second threshold value Ap2 is more specifically an amplitude feature Apc from the post-correction amplitude A2a of the second incoming signal S2r.

In the present embodiment, one determination that the post-correction amplitude A2a of the second incoming signal S2r is higher than or equal to the second threshold value Ap2 does not immediately lead to the determination that the object B has been detected, but acts on affirming that the object B has been detected on the basis of the second incoming signal S2r.

Here, a dashed line L2a in FIG. 8 represents a pre-correction amplitude of the second incoming signal S2r that has not been corrected by the second STC processing, more specifically an amplitude feature Apc of the pre-correction amplitude. In an example of FIG. 8, as is understandable from the relationship between the post-correction amplitude A2a of the second incoming signal S2r and the second threshold value Ap2, the post-correction amplitude A2a of the second incoming signal S2r is determined to be lower than the second threshold value Ap2.

As described above, the second signal processing includes the second STC processing and the second-threshold-value-based processing, and in the second signal processing, the second STC processing and the second-threshold-value-based processing are sequentially executed. Therefore, the second condition employed in the second signal processing consists of the second STC 52 and the second threshold value Ap2. The determination processing section 253 does not perform the second signal processing using the amplitude signal Sap itself, but performs the second signal processing using the amplitude feature Apc extracted from the amplitude signal Sap.

Here, a difference between the first STC 51 and the second STC 52 is described. Compared with the first STC 51, the second STC is formed so that the relationship between the lapse time T and the gain G is shifted in the direction of increasing the lapse time T by the delay time ΔT. Then, a difference between the first threshold value Ap1 and the second threshold value Ap2 is described. The relationship between the lapse time T and the second threshold value Ap2 is shifted in the direction of increasing the lapse time T by the delay time ΔT with respect to the relationship between the lapse time T and the first threshold value Ap1.

For example, when the delay time ΔT is varied, the determination processing section 253 shifts the relationship between the lapse time T and the gain G of the second STC 52 in the direction of increasing the lapse time T, along with the increase of the delay time ΔT, with respect to the relationship between the lapse time T and the gain G of the first STC 51. Further, the determination processing section 253 shifts the relationship between the lapse time T and the second threshold value Ap2 in the direction of increasing the lapse time T, along with the increase of the delay time ΔT, with respect to the relationship between the lapse time T and the first threshold value Ap1. In short, the determination processing section 253 changes the second threshold value Ap2 based on the delay time ΔT.

As described above, the first condition and the second condition are different because the first STC 51 and the second STC 52 have different relationships between a lapse time T and the gain G determined based on the lapse time T. Further, the first condition and the second condition are different also because the relationship between a lapse time T and the first threshold value Ap1 determined based on the lapse time T is different from the relationship between a lapse time T and the second threshold value Ap2 determined based on the lapse time T.

Time 0 in the lapse time T on the horizontal axis in FIG. 8 is the moment when the first transducer 211 has started the transmission of the search wave Sw, and moment T1 is the moment when the second transducer 212 has started the transmission of the search wave Sw.

After completion of the second signal processing, the determination processing section 253 transmits a processing result of the second signal processing and a feature of the second incoming signal S2r to the communication bus 3a in step S062 of FIG. 4. Then, the processing result of the second signal processing and the feature of the second incoming signal S2r transmitted to the communication bus 3a are input from the communication bus 3a to the detection result acquisition section 33 of the controller 3.

The processing result of the second signal processing is a determination result of the second-threshold-value-based processing. The feature of the second incoming signal S2r consists of, for example, the amplitude feature Apc from the post-correction amplitude A2a of the second incoming signal S2r, the code representing the transmission source corresponding to the second incoming signal S2r, and TOF of the second incoming signal S2r. The processing result of the second signal processing is also output to the detection determination section 254.

The cases in which the code identification in step S04 of FIG. 4 is successful have been described above, but there can be cases in which the code identification fails. In such cases, when the code identification in step S04 has failed, in other words, when a plurality of incoming signals originating from different transmission sources have not been able to be distinguished, the determination processing section 253 performs signal processing for cases of code non-identification in step S07 of FIG. 4.

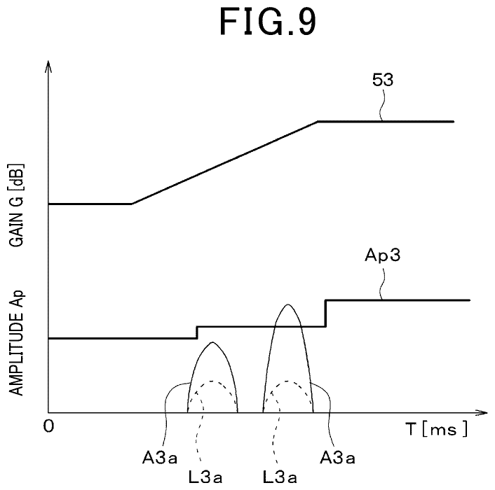

Specifically, in the signal processing for cases of code non-identification, the determination processing section 253 executes non-identification STC processing for correcting an incoming signal Sr by a prescribed non-identification STC 53 as illustrated in FIG. 9. In detail, in the non-identification STC processing, the determination processing section 253 amplifies all amplitude features Apc, which have been extracted by the feature extractor 252, by the non-identification STC 53. Further, in the signal processing for cases of code non-identification, the determination processing section 253 also executes non-identification-threshold-value-based processing for determining whether post-correction amplitudes A3a of the incoming signal Sr obtained through the correction by the non-identification STC 53 are higher than or equal to a prescribed non-identification threshold value Ap3.

In this processing, the post-correction amplitudes A3a of the incoming signal Sr, which are the subjects of determination, are more specifically amplitudes obtained by correcting all the amplitude features Apc, which have been extracted by the feature extractor 252, by the non-identification STC 53. Accordingly, the subjects to be determined whether they are higher than or equal to the non-identification threshold value Ap3 are more specifically amplitude features Apc from the post-correction amplitudes A3a of the incoming signal Sr.

The non-identification STC 53 may be, for example, the same as any of the STCs employed in steps S051 to S05n. Alternatively, the non-identification STC 53 may be set so that the gain G constituting the non-identification STC 53 is an average value of the gains G of the STCs employed in steps S051 to S05n for the segments of the lapse time T.

The non-identification threshold value Ap3 is preliminarily set through experiments so that the post-correction amplitudes A3a of the incoming signal Sr become higher than or equal to the non-identification threshold value Ap3 when the possibility that a reflected wave from the object B has existed is somewhat high. For example, the non-identification threshold value Ap3 may be set to a minimum value of the threshold values, such as the first and second threshold values Ap1, Ap2, employed in steps S051 to S05n for the segments of the lapse time T.

Here, dashed lines L3a in FIG. 9 represent pre-correction amplitudes of the incoming signals Sr that have not been corrected by the non-identification STC processing, more specifically amplitude features Apc of the pre-correction amplitudes. In an example of FIG. 9, as is understandable from the relationship between the post-correction amplitudes A3a of the incoming signals Sr and the non-identification threshold value Ap3, a post-correction amplitude A3a of an incoming signal Sr is determined to be higher than or equal to the non-identification threshold value Ap3. In step S07 of FIG. 4, a processing result of the signal processing for cases of code non-identification, that is, a determination result of the non-identification-threshold-value-based processing is output to the detection determination section 254.

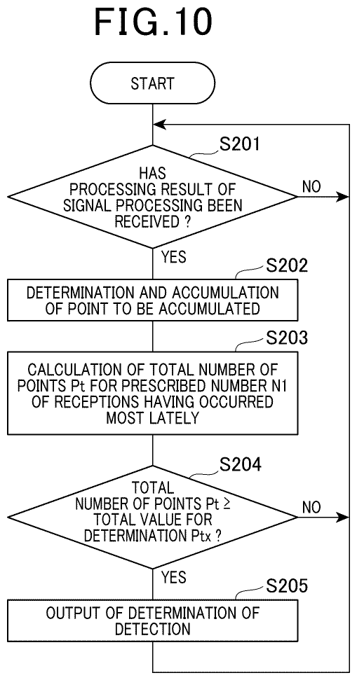

The detection determination section 254 in FIG. 3 determines the detection of the object B on the basis of the processing result of the signal processing performed by the determination processing section 253. Specifically, the detection determination section 254 executes control processing in FIG. 10.

In step S201 of FIG. 10, the detection determination section 254 determines whether the processing result of the signal processing performed by the determination processing section 253 has been received from the determination processing section 253.

In step S201, when it is determined that the processing result of the signal processing has been received, the process proceeds to step S202. On the other hand, when it is determined that the processing result of the signal processing has not been received yet, step S201 is repeated.

In step S202, the detection determination section 254 determines a point to be accumulated based on the received processing result of the signal processing, more specifically the determination result of the threshold-value-based processing included in the signal processing, and stores the determined point to be accumulated in a storage device such as a memory. Storing the point to be accumulated in a storage device is, in other words, accumulating the point to be accumulated in a storage device.

In detail, for each of the transmission sources of the search waves Sw having the codes thereof identified, the detection determination sections 254 determine a point that is to be accumulated and is based on the determination result of the threshold-value-based processing, and stores the point.

For example, when the post-correction amplitude A1a of the first incoming signal S1r has been determined to be higher than or equal to the first threshold value Ap1 in the first signal processing, the detection determination section 254 determines a prescribed detection point as the point to be accumulated, and stores the point to be accumulated in a storage device. On the other hand, when the post-correction amplitude A1a of the first incoming signal S1r has been determined to be lower than the first threshold value Ap1 in the first signal processing, the detection determination section 254 determines a prescribed non-detection point as the point to be accumulated, and stores the point to be accumulated in the storage device. For example, the detection point is set to “1”, and the non-detection point is set to “−1” which is lower than the detection point.

The point that is to be accumulated and is based on the determination result of the threshold-value-based processing in steps S052 to S05n is similarly stored as “1” or “−1”. The second signal processing is described as an example. When the post-correction amplitude A2a of the second incoming signal S2r has been determined to be higher than or equal to the second threshold value Ap2 in the second signal processing, the detection determination section 254 determines the detection point as the point to be accumulated, and stores the point to be accumulated in the storage device. On the other hand, when the post-correction amplitude A2a of the second incoming signal S2r has been determined to be lower than the second threshold value Ap2 in the second signal processing, the detection determination section 254 determines the non-detection point as the point to be accumulated, and stores the point to be accumulated in the storage device.

In step S202, the detection determination section 254 also determines the point to be accumulated when the code has not been able to be identified. That is, when the post-correction amplitude A3a of the incoming signal Sr has been determined to be higher than or equal to the non-identification threshold value Ap3 in the signal processing for cases of code non-identification, the detection determination section 254 determines a prescribed non-identification point as the point to be accumulated, and stores the point to be accumulated in the storage device. The non-identification point is a point lower than the detection point but higher than the non-detection point, and is set to, for example, “0”. On the other hand, when the post-correction amplitude A3a of the incoming signal Sr has been determined to be lower than the non-identification threshold value Ap3 in the signal processing for cases of code non-identification, the detection determination section 254 determines the non-detection point as the point to be accumulated, and stores the point to be accumulated in the storage device.

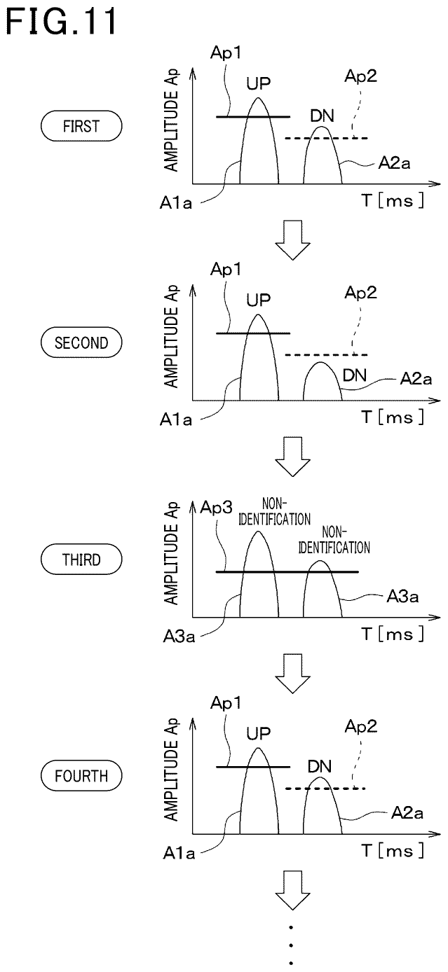

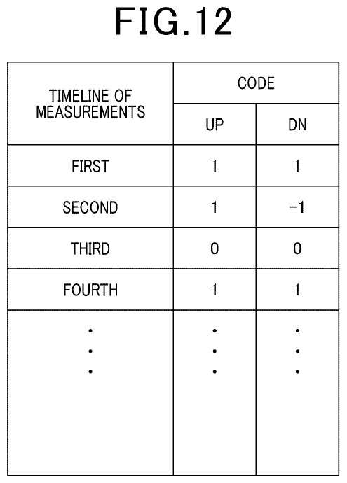

Determining the point to be accumulated in step S202 is described with an example of FIGS. 11 and 12. FIGS. 11 and 12 respectively illustrate the signal processing results for the first to forth receptions of incoming waves Rw that have occurred along the time series, and the points that are to be accumulated and have been determined based on the determination results.

For example, as illustrated in FIG. 11, the code identification has been successful in the signal processing for the first reception of incoming waves Rw. Then, in the first reception of incoming waves Rw, the post-correction amplitude A1a of the first incoming signal S1r has been determined to be higher than or equal to the first threshold value Ap1 in the first signal processing, and the post-correction amplitude A2a of the second incoming signal S2r has been determined to be higher than or equal to the second threshold value Ap2 in the second signal processing.

Therefore, as illustrated in FIG. 12, in the first reception of incoming waves Rw the signal processing result corresponding to the code “UP” is assigned “1” as the point to be accumulated. Further, the signal processing result corresponding to the code “DN” is also assigned “1” as the point to be accumulated.

As illustrated in FIG. 11, the code identification has been successful in the signal processing for the second reception of incoming waves Rw. Then, in the second reception of incoming waves Rw, the post-correction amplitude A1a of the first incoming signal S1r has been determined to be higher than or equal to the first threshold value Ap1 in the first signal processing, and the post-correction amplitude A2a of the second incoming signal S2r has been determined to be lower than the second threshold value Ap2 in the second signal processing.

Therefore, as illustrated in FIG. 12, in the second reception of incoming waves Rw, the signal processing result corresponding to the code “UP” is assigned “1” as the point to be accumulated. Further, the signal processing result corresponding to the code “DN” is assigned “−1” as the point to be accumulated.

As illustrated in FIG. 11, the code identification has failed in the signal processing for the third reception of incoming waves Rw. Then, in the third reception of incoming waves Rw, the post-correction amplitudes A3a of the incoming signals Sr have been determined to be higher than or equal to the non-identification threshold value Ap3 in the signal processing for cases of code non-identification.

Therefore, as illustrated in FIG. 12, in the third reception of incoming waves Rw, the signal processing result corresponding to each code is assigned “0” as the point to be accumulated. For example, each of the signal processing result corresponding to the code “UP” and the signal processing result corresponding to the code “DN” is assigned “0” as the point to be accumulated. Here, the “non-identification” described in FIG. 11 means that the code has been unidentified.

As illustrated in FIG. 11, the code identification has been successful in the signal processing for the fourth reception of incoming waves Rw. Then, in the fourth reception of incoming waves Rw, the post-correction amplitude A1a of the first incoming signal S1r has been determined to be higher than or equal to the first threshold value Ap1 in the first signal processing, and the post-correction amplitude A2a of the second incoming signal S2r has been determined to be higher than or equal to the second threshold value Ap2 in the second signal processing.

Therefore, as illustrated in FIG. 12, in the fourth reception of incoming waves Rw, the signal processing result corresponding to the code “UP” is assigned “1” as the point to be accumulated. Further, the signal processing result corresponding to the code “DN” is also assigned “1” as the point to be accumulated. The point that is to be accumulated and has been thus assigned is accumulated in the storage device in each assignment. Following step S202 of FIG. 10, the process proceeds to step S203.

In step S203 of FIG. 10, the detection determination section 254 reads the points to be accumulated from the storage device, and calculates a total number of points Pt for the signal processing results corresponding to each code by summing the points that are to be accumulated and have been assigned to the signal processing results. Then, after calculating the total number of points Pt, the detection determination section 254 determines whether the total number of points Pt for the signal processing results corresponding to each code is higher than or equal to a prescribed total value for determination Ptx in S204.

In step S204, when any one of the total numbers of points Pt for the signal processing results respectively corresponding to the codes is determined to be higher than or equal to the total value for determination Ptx, the process proceeds to step S205. Having determined that any one of the total numbers of points Pt for the signal processing results, respectively corresponding to the codes, is higher than or equal to the total value for determination Ptx means having determined that the object B has been detected in the signal processing involving that determination.

On the other hand, in step S204, when all the total numbers of points Pt for the signal processing results, respectively corresponding to the codes, is determined to be lower than the total value for determination Ptx, the process proceeds to step S201.

Specifically, the total value for determination Ptx used in step S204 is preliminarily set through experiments so that the detection of the object B can be promptly and accurately determined. The total value for determination Ptx is not particularly limited, but is set to 3 in the present embodiment.

The total number of points Pt calculated in step S203 is a score calculated for the signal processing results corresponding to each code, and a score obtained by summing the points that are to be accumulated and have been accumulated over a prescribed number N1 of two or more receptions having consecutively occurred most lately over time. The prescribed number N1 of receptions is preliminarily set so that even if a plurality of points to be accumulated, which are bases of the total number of points Pt, include one non-identification point, the determination made in step S204 gives “Pt≥Ptx” in some cases. The prescribed number N1 of receptions may be 5 or more, but is set to 4 in the present embodiment.

For example, in the example of FIG. 12, the total number of points Pt is calculated by summing the points accumulated for the latest four receptions, that is, the points accumulated at the first to fourth receptions, at the moment of the fourth accumulation of points that is the moment when the points to be accumulated have been assigned to the signal processing results for the fourth reception of incoming waves Rw and accumulated. That is, at the moment of the fourth accumulation of points, the total number of points Pt for the signal processing results corresponding to the code “UP” is 3. On the other hand, the total number of points Pt for the signal processing results corresponding to the code “DN” is 1.

Accordingly, in this case, the total number of points Pt for the signal processing results corresponding to the code “UP” is determined to be higher than or equal to the total value for determination Ptx in step S204. Then, the total number of points Pt for the signal processing results corresponding to the code “DN” is determined to be lower than the total value for determination Ptx. That is, the object B is determined to have been detected in the first signal processing, and the object B is determined to have not yet been detected in the second signal processing. As a result, the process of FIG. 10 proceeds from step S204 to step S205.

In step S205, the detection determination section 254 outputs, to the detection result acquisition section 33 of the controller 3 via the communication bus 3a, a code representing the signal processing results whose total number of points Pt has been determined to be higher than or equal to the total value for determination Ptx, and a result of the determination of detection that, in the signal processing corresponding to the code, the object B has been detected. Together with the code and the result, the detection determination section 254 also outputs, to the detection result acquisition section 33, information enabling identification of the ultrasonic sensor 2 associated with the result of the determination of detection that the object B has been detected, that is, information enabling identification of the ultrasonic sensor 2 that includes the detection determination section 254 of the result. Following step S205, the process proceeds to step S201.

The detection result acquisition section 33 of the controller 3 illustrated in FIG. 1 acquires, from each of the plurality of ultrasonic sensors 2, information based on the incoming signal Sr received by each of the plurality of ultrasonic sensors 2. Then, the detection result acquisition section 33 executes various kinds of control processing according to the information based on the incoming signal Sr acquired.

For example, when receiving from an ultrasonic sensor 2 a result of the determination of detection that the object B has been detected, the detection result acquisition section 33 identifies the ultrasonic sensor 2 that has output the result of the determination of detection. Then, the detection result acquisition section 33 estimates the distance from the transducer 21 of the identified ultrasonic sensor 2 to the object B on the basis of, for example, the feature of the incoming signal for each code received from the ultrasonic sensor 2.

As described above, in the present embodiment, the determination processing section 253 performs the first signal processing, which is signal processing for the first incoming signal S1r, under the prescribed first condition. Then, the determination processing section 253 performs the second signal processing, which is signal processing for the second incoming signal S2r, under the prescribed second condition. Here, the second condition is different from the first condition.

Accordingly, the first condition, which is a signal processing condition for performing the first signal processing, and the second condition, which is a signal processing condition for performing the second signal processing, need not be standardized and can be set separately. Therefore, it is possible to appropriately perform the first signal processing on the first incoming signal S1r under the first condition, and appropriately perform the second signal processing on the second incoming signal S2r under the second condition. As a result, each of the first signal processing and the second signal processing enables a reflected wave from the object B to be appropriately detected.

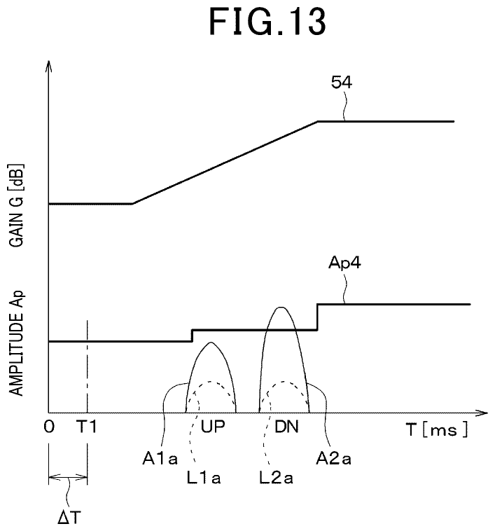

Here, as illustrated in FIG. 13, a comparative example is considered in which first signal processing and second signal processing are performed under a signal processing condition consisting of a single STC 54 and a single threshold value Ap4. In this comparative example, when the signal processing condition consisting of the STC 54 and the threshold value Ap4 is set appropriately for one of the first signal processing and the second signal processing, the set signal processing condition deviates from a signal processing condition appropriate for the other of the first signal processing and the second signal processing. Accordingly, the first signal processing and the second signal processing can each be appropriately performed in the present embodiment compared with this comparative example.

(1) In the present embodiment, the determination processing sections 253 included in the incoming signal processors 25 transmit, to the communication bus 3a, the processing result of the first signal processing and the feature of the first incoming signal S1r, and the processing result of the second signal processing and the feature of the second incoming signal S2r. Accordingly, it is possible to reduce the communications traffic in the transmission from the ultrasonic sensors 2 to the communication bus 3a, compared with, for example, the cases in which an amplitude signal Sap generated from an incoming signal Sr is transmitted to a communication bus 3a without information filtering of the amplitude signal Sap.

(2) In the present embodiment, the incoming signal processors 25 extract, from the amplitude signal Sap, the amplitude feature Apc that is a feature from the amplitude Ap of the incoming signal Sr. Then, the incoming signal processors 25 perform the first signal processing and the second signal processing using the amplitude feature Apc.

Accordingly, the amount of information processed in the first signal processing and the second signal processing is reduced, compared with the cases in which first signal processing and second signal processing are performed on raw amplitude signals Sap. Therefore, the processing load for performing the first signal processing and the second signal processing is reduced, and the first signal processing and the second signal processing can be executed by software processing performed by, for example, a simple computer that can be mounted in the ultrasonic sensor 2.

(3) In the present embodiment, the feature extractor 252 included in the incoming signal processor 25 extracts, as the amplitude feature Apc, a portion, in which a local maximum of the amplitude Ap of the incoming signal Sr exceeds the prescribed reflected-wave threshold value Apx, from the amplitude signal Sap representing the amplitude Ap of the incoming signal Sr. Accordingly, from among the information contained in the amplitude signal Sap, unnecessary information, which is not needed for the threshold-value-based processing performed after the extraction of the amplitude feature APC, can be reduced. That is, it is possible to achieve the reduction of the processing load in the signal processing, such as the first signal processing and the second signal processing, performed after the extraction of the amplitude feature Apc.

(4) In the present embodiment, as illustrated in FIG. 8, the relationship between the lapse time T and the second threshold value Ap2 is increasingly shifted in the direction of increasing the lapse time T, along with the increase of the delay time ΔT, with respect to the relationship between the lapse time T and the first threshold value Ap1.

Thereby, the first-threshold-value-based processing and the second-threshold-value-based processing absorb the temporal shift of the delay time ΔT generated between the first incoming signal S1r and the second incoming signal S2r. Accordingly, the first-threshold-value-based processing and the second-threshold-value-based processing can each be appropriately performed, compared with the cases in which a first threshold value Ap1 and a second threshold value Ap2 are always the same level with respect to a lapse time T.

(5) In the present embodiment, the relationship between the lapse time T and the gain G of the second STC 52 is shifted in the direction of increasing the lapse time T, along with the increase of the delay time ΔT, with respect to the relationship between the lapse time T and the gain G of the first STC 51.

Thereby, the first STC processing and the second STC processing absorb the temporal shift of the delay time ΔT generated between the first incoming signal S1r and the second incoming signal S2r. Accordingly, the first STC processing and the second STC processing can each be appropriately performed, compared with the cases in which a first STC 51 and a second STC 52 have the identical relationship between a lapse time T and a gain G.

(6) In the present embodiment, when the total number of points Pt obtained by summing the points that are to be accumulated and have been assigned to the processing results of the first signal processing over the prescribed number N1 of receptions having occurred most lately is higher than or equal to the total value for determination Ptx, the detection determination section 254 determines that the object B has been detected in the first signal processing. When the post-correction amplitude A3a of the incoming signal Sr has been determined to be higher than or equal to the non-identification threshold value Ap3 in the signal processing for cases of code non-identification, the detection determination section 254 determines the prescribed non-identification point as the point to be accumulated, and accumulates the point to be accumulated in the storage device. The non-identification point is a point lower than the detection point but higher than the non-detection point.

Accordingly, even in the cases when the code identification for the incoming signal Sr has failed, when the possibility that a reflected wave from the object B has been obtained is high, an intermediate weighting can be applied that refers to a weight between when the code determination has been successful and a reflected wave from the object B has been obtained in the determination of detection of the object B based on the first signal processing and when this is not the case. Therefore, without decreasing the accuracy of the determination of detection of the object B, the result of determining whether the object B has been detected can be promptly provided. The same applies to the determination of detection of the object B based on signal processing other than the first signal processing, such as the determination of detection of the object B based on the second signal processing.

### Second Embodiment

Next, a second embodiment is described. In the present embodiment, points different from the first embodiment are mainly described. Parts that are identical or equivalent to those of the former embodiment are not described or described in a simple manner. The same applies to the embodiments described later.

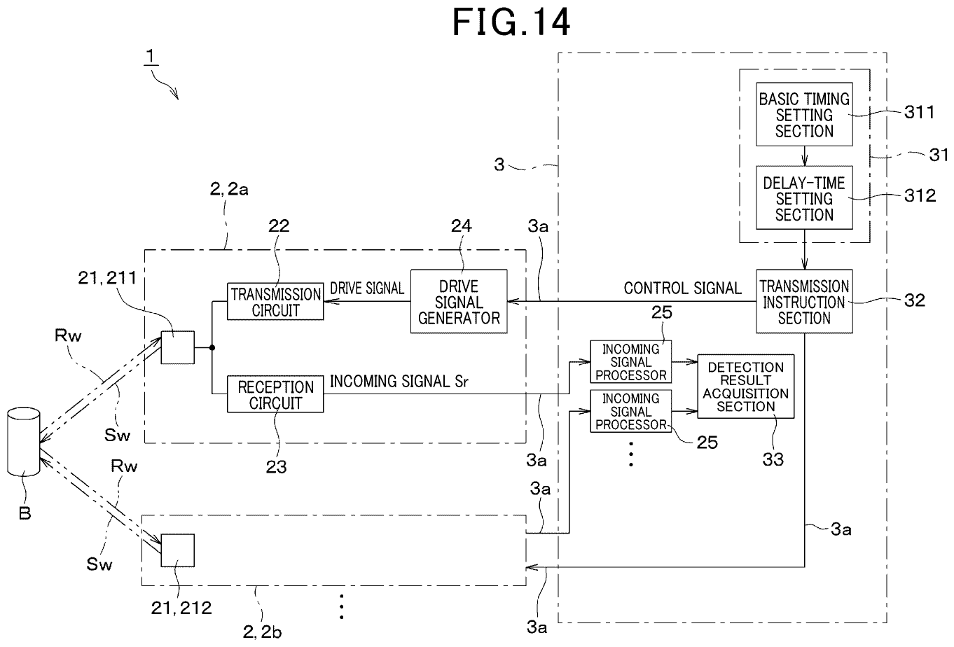

As illustrated in FIG. 14, in the present embodiment, an incoming signal processor 25 is provided at a place different from the place in the first embodiment. That is, in the present embodiment, each of a plurality of ultrasonic sensors 2 does not include the incoming signal processor 25, but a controller 3 includes a plurality of incoming signal processor 25 provided so as to respectively correspond to the ultrasonic sensors 2. Accordingly, incoming signals Sr are input from reception circuits 23 of the ultrasonic sensors 2 to the plurality of incoming signal processors 25 via a communication bus 3a.

Except for the matters described above, the present embodiment is the same as the first embodiment. In addition, the present embodiment can give the same effects as the first embodiment through configurations common to both embodiments.

### Third Embodiment

Next, a third embodiment is described. In the present embodiment, points different from the first embodiment are mainly described.

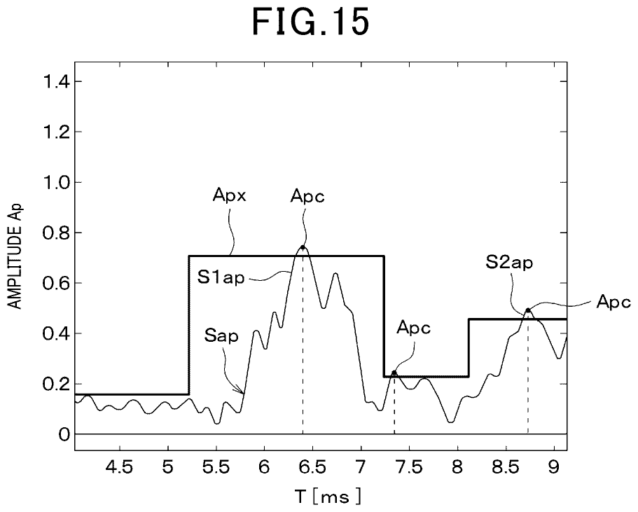

As illustrated in FIG. 15, in the present embodiment, a reflected-wave threshold value Apx used in step S03 of FIG. 4 is a dynamic threshold value because the relationship between the reflected-wave threshold value Apx and a lapse time T is determined based on the waveform of an amplitude signal Sap. Examples of the dynamic threshold value include CFAR. CFAR is an abbreviation for “Constant False Alarm Rate”.

Except for the matters described above, the present embodiment is the same as the first embodiment. In addition, the present embodiment can give the same effects as the first embodiment through configurations common to both embodiments.

While the present embodiment is a modified example based on the first embodiment, the present embodiment can be combined with the second embodiment.

### Fourth Embodiment

Next, a fourth embodiment is described. In the present embodiment, points different from the first embodiment are mainly described.

In the present embodiment, a reflected-wave threshold value Apx used in step S03 of FIG. 4 is changed based on a delay time ΔT. In the present embodiment, a reason why the reflected-wave threshold value Apx is changed this way is described below.

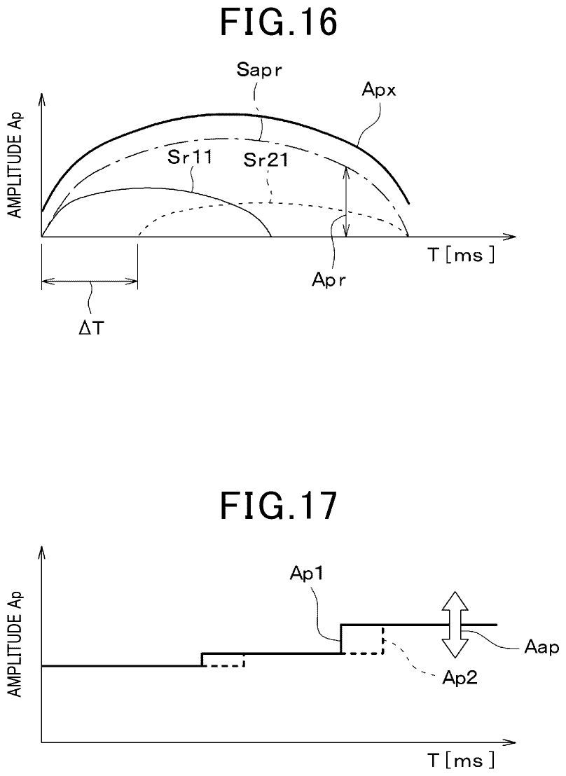

The reflected-wave threshold value Apx is used to reduce the amount of information contained in an amplitude signal Sap without adversely affecting the determination of detection of an object B. Therefore, as illustrated in FIG. 16, the reflected-wave threshold value Apx is desired to be set so that a road-surface reflection amplitude Apr is below the reflected-wave threshold value Apx, the road-surface reflection amplitude Apr being an amplitude Ap of an incoming signal Sr that is caused by reflection of an ultrasonic wave from the road surface and corresponds to noise or the like.

FIG. 16 illustrates an example in which a road-surface reflection amplitude signal Sapr representing a relationship between the road-surface reflection amplitude Apr and a lapse time T is obtained by a first transducer 211 receiving incoming waves Rw originating from the first transducer 211 and a second transducer 212 as the transmission sources. In this example, the incoming waves Rw received by the first transducer 211 in FIG. 2 include a first incoming wave R11 and a second incoming wave R21. The first incoming wave R11 is a reflected wave produced by reflection of a search wave Sw originating from the first transducer 211 as the transmission source, and the second incoming wave R21 is a reflected wave produced by reflection of a search wave Sw originating from the second transducer 212 as the transmission source.

Further, a first road-surface reflection amplitude signal Sr11 illustrated in FIG. 16 is an amplitude signal Sap based on the first incoming wave R11 generated by reflection from only the road surface, not the object B. A second road-surface reflection amplitude signal Sr21 is an amplitude signal Sap based on the second incoming wave R21 generated by reflection from only the road surface, not the object B, and is formed to be shifted in the direction of increasing the lapse time T by the delay time ΔT with respect to the first road-surface reflection amplitude signal Sr11. The shift by the delay time ΔT between the signals is generated because, as described above, after the lapse of the delay time ΔT from the moment when the first transducer 211 has started the transmission of the search wave Sw, the second transducer 212 starts the transmission of the search wave Sw.

As illustrated in FIG. 16, the road-surface reflection amplitude signal Sapr is obtained as a synthesized signal obtained by summing the first road-surface reflection amplitude signal Sr11 and the second road-surface reflection amplitude signal Sr21, and therefore varies based on the delay time ΔT. Thus, in the present embodiment, the reflected-wave threshold value Apx is changed based on the delay time ΔT as described above.

For example, a representative road-surface reflection amplitude signal Sapr that varies based the delay time ΔT is preliminarily derived through experiments, and on the basis of the road-surface reflection amplitude signal Sapr, a reflected-wave-threshold-value map is preliminarily set that fixes a relationship between a reflected-wave-threshold-value-related line, representing a relationship between the reflected-wave threshold value Apx and the lapse time T, and the delay time ΔT. In the reflected-wave-threshold-value map, the reflected-wave threshold value Apx exceeds a road-surface reflection amplitude Apr of the representative road-surface reflection amplitude signal Sapr, which has been preliminarily derived through experiments, at any lapse time T. A feature extractor 252 of the present embodiment determines the reflected-wave-threshold-value-related line on the basis of the delay time ΔT according to the reflected-wave-threshold-value map prior to the extraction of an amplitude feature Apc.

As described above, the reflected-wave threshold value Apx is changed based on the delay time ΔT, and the same applies to threshold values such as first and second threshold values Ap1, Ap2 used in threshold-value-based processing in steps S051 to S05n of FIG. 4. This is to prevent erroneous determination of detection of the object B caused by the reflection from the road surface.

Accordingly, the threshold values such as the first and second threshold values Ap1, Ap2 used in the threshold-value-based processing in steps S051 to S05n of FIG. 4 are also changed based on the delay time ΔT as illustrated by an arrow Aap in FIG. 17. For example, relationships between the threshold values such as the first and second threshold values Ap1, Ap2 and the delay time ΔT are preliminarily set as maps through experiments, and the threshold values are determined before the use thereof according to the maps.

For example, along with the increase in the maximum value of an amplitude Ap of a post-correction signal obtained by performing STC processing on the representative road-surface reflection amplitude signal Sapr preliminarily derived, the threshold values such as the first and second threshold values Ap1, Ap2 are shifted in the direction of increasing the amplitude AP on the vertical axis in FIG. 17. In the maps used for this procedure, the threshold values such as the first and second threshold values Ap1, Ap2 exceed the post-correction amplitude value at any lapse time T, the post-correction amplitude value being obtained by correcting, using the STC processing, the road-surface reflection amplitude Apr of the representative road-surface reflection amplitude signal Sapr preliminarily derived.

(1) As described above, in the present embodiment, the reflected-wave threshold value Apx is changed based on the delay time ΔT. Accordingly, the reflected-wave threshold value Apx can be set to an appropriate value so that, for example, the reflection of an ultrasonic wave from the road surface is eliminated and the detection of the object B can be accurately determined.

(2) In the present embodiment, the first threshold value Ap1 and the second threshold value Ap2 are changed based on the delay time ΔT. Accordingly, the first threshold value Ap1 and the second threshold value Ap2 can be set to appropriate values so that, for example, the reflection of an ultrasonic wave from the road surface is eliminated and the detection of the object B can be accurately determined.

Except for the matters described above, the present embodiment is the same as the first embodiment. In addition, the present embodiment can give the same effects as the first embodiment through configurations common to both embodiments.

While the present embodiment is a modified example based on the first embodiment, the present embodiment can be combined with the second embodiment.

### Fifth Embodiment

Next, a fifth embodiment is described. In the present embodiment, points different from the first embodiment are mainly described.

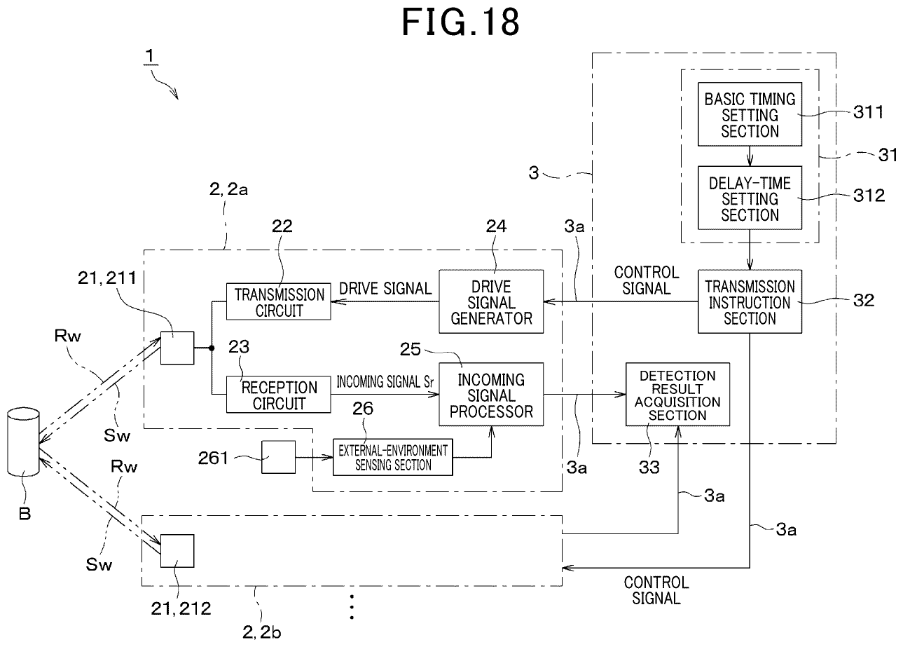

As illustrated in FIG. 18, a plurality of ultrasonic sensors 2 each include an external-environment sensing section 26. The external-environment sensing section 26 senses an external environment that affects an amplitude Ap of an incoming signal Sr, and outputs external-environment information EN representing the external environment to an incoming signal processor 25. The external environment sensed by the external-environment sensing section 26 is variously considered, and the external-environment sensing section 26 of the present embodiment senses a road-surface roughness in the surroundings of the own vehicle as the external environment that affects the amplitude Ap of the incoming signal Sr. For confirmation, the external environment does not include an object B to be detected.

For example, the external-environment sensing section 26 has a camera 261 electrically connected thereto, the camera 261 capturing an image in the surroundings of the own vehicle. The external-environment sensing section 26 estimates the road-surface roughness from the image captured by the camera 261, and outputs to the incoming signal processor 25 the external-environment information EN representing the road-surface roughness estimated.

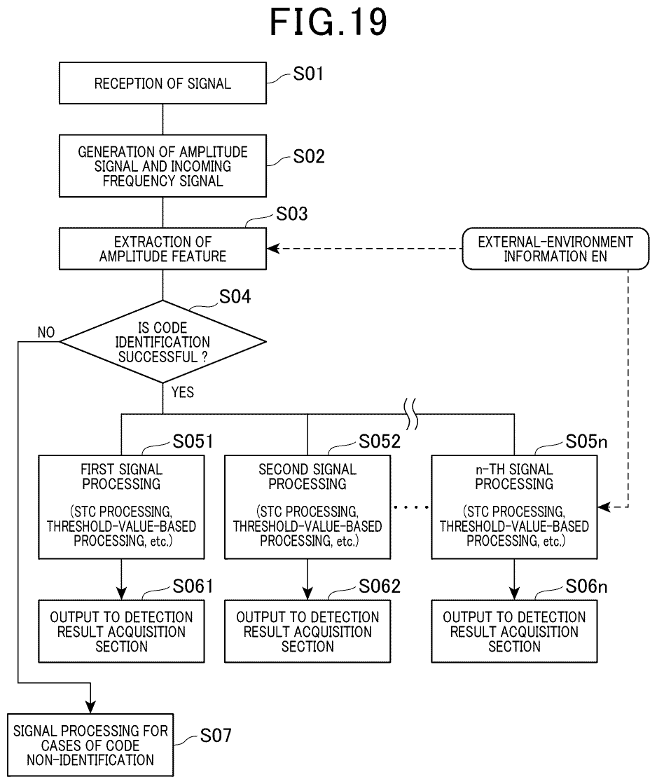

The external-environment information EN is received by a feature extractor 252 and a determination processing section 253 of the incoming signal processor 25. After the reception of the external-environment information EN, the feature extractor 252 determines a reflected-wave-threshold-value-related line representing a relationship between a reflected-wave threshold value Apx and a lapse time T on the basis of the road-surface roughness represented by the external-environment information EN according to a prescribed reflected-wave-threshold-value map in step S03 of FIG. 19.

Thus, prior to the extraction of an amplitude feature Apc, the reflected-wave threshold value Apx used for the extraction of the amplitude feature Apc is changed based on the road-surface roughness as the external environment sensed by the external-environment sensing section 26. Except for the points described in the present embodiment, the steps of FIG. 19 are the same as the steps of FIG. 4 that have the same reference signs as the steps in FIG. 19.

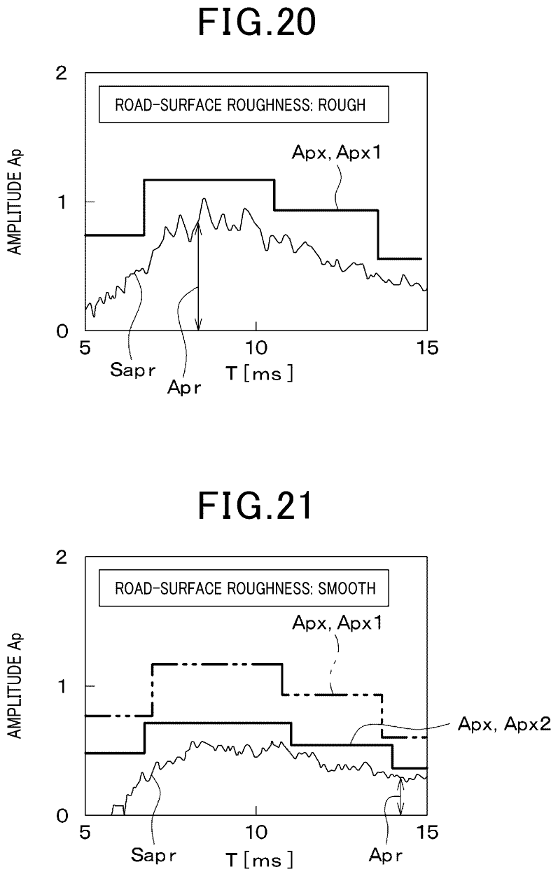

Here, FIG. 20 illustrates a road-surface reflection amplitude signal Sapr obtained when the road-surface roughness of a road surface captured by the camera 261 is a first road-surface roughness, and a reflected-wave threshold value Apx determined based on the first road-surface roughness. FIG. 21 illustrates a road-surface reflection amplitude signal Sapr obtained when the road-surface roughness of a road surface captured by the camera 261 is a second road-surface roughness, and illustrates a reflected-wave threshold value Apx determined based on the second road-surface roughness by a solid line. The first road-surface roughness is rougher than the second road-surface roughness.

In order to differentiate the reflected-wave threshold values Apx corresponding to the first and second road-surface roughnesses from each other, the reference sign “Apx1” is assigned to the reflected-wave threshold value Apx corresponding to the first road-surface roughness and the reference sign “Apx2” is assigned to the reflected-wave threshold value Apx corresponding to the second road-surface roughness. In addition, for the comparison of the reflected-wave threshold value Apx1 with the reflected-wave threshold value Apx2, the reflected-wave threshold value Apx1 is transcribed by a dash-dot-dot line on FIG. 21.

As illustrated in FIGS. 20 and 21, the road-surface reflection amplitude signal Sapr that varies based the road-surface roughness is preliminarily derived through experiments, and on the basis of the road-surface reflection amplitude signal Sapr, a relationship between the reflected-wave-threshold-value-related line, representing the relationship between the reflected-wave threshold value Apx and the lapse time T, and the road-surface roughness is preliminarily set as the reflected-wave-threshold-value map.

In the reflected-wave-threshold-value map, the reflected-wave threshold value Apx slightly exceeds a road-surface reflection amplitude Apr of the road-surface reflection amplitude signal Sapr at any lapse time T. The reflected-wave-threshold-value-related line is shifted in the direction of increasing the amplitude Ap on the vertical axis in FIG. 21 along with the increase in roughness of the road-surface roughness.

As described above, the reflected-wave threshold value Apx is changed based on the road-surface roughness, and the same applies to threshold values such as first and second threshold values Ap1, Ap2 used in threshold-value-based processing in steps S051 to S05n of FIG. 19. This is to prevent erroneous determination of detection of the object B caused by the reflection from the road surface.

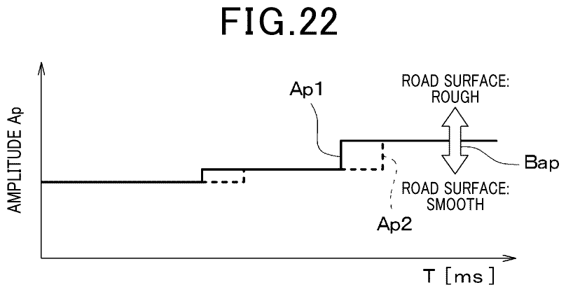

Accordingly, the threshold values such as the first and second threshold values Ap1, Ap2 used in the threshold-value-based processing in steps S051 to S05n of FIG. 19 are also changed based on the road-surface roughness as the external environment sensed by the external-environment sensing section 26 as illustrated by an arrow Bap in FIG. 22. For example, relationships between the threshold values such as the first and second threshold values Ap1, Ap2 and the road-surface roughness are preliminarily set as maps through experiments, and the threshold values are determined before the use thereof according to the maps.

Specifically, the threshold values such as the first and second threshold values Ap1, Ap2 are shifted in the direction of increasing the amplitude Ap on the vertical axis in FIG. 22 along with the increase in roughness of the road-surface roughness. In the maps used for this procedure, the threshold values such as the first and second threshold values Ap1, Ap2 exceed a post-correction amplitude value at any lapse time T, the post-correction amplitude value being obtained by correcting, using STC processing, the road-surface reflection amplitude Apr of the road-surface reflection amplitude signal Sapr preliminarily derived through experiments.

(1) As described above, in the present embodiment, the reflected-wave threshold value Apx is changed based on the road-surface roughness as the external environment sensed by the external-environment sensing section 26. An influence of the external environment on the incoming signal Sr, such as reflection of an ultrasonic wave from the road surface, corresponds to noise or the like to detect the object B, and it is desired no such noise or anything similar exists. Accordingly, the reflected-wave threshold value Apx can be set to an appropriate value so that the influence of the external environment on the incoming signal Sr is eliminated and the detection of the object B can be accurately determined. That is, even if the external environment in the surroundings of the own vehicle varies, the performance of ON for detecting a subject intended to be detected by an ultrasonic wave and the performance of OFF for not detecting a subject not intended to be detected by an ultrasonic wave can be appropriately secured.

(2) In the present embodiment, the first threshold value Ap1 and the second threshold value Ap2 are changed based on the road-surface roughness as the external environment sensed by the external-environment sensing section 26. Accordingly, the first threshold value Ap1 and the second threshold value Ap2 can be set to appropriate values so that the influence of the external environment on the incoming signal Sr is eliminated and the detection of the object B can be accurately determined. That is, the performance of ON and the performance of OFF described above can be appropriately secured.

Except for the matters described above, the present embodiment is the same as the first embodiment. In addition, the present embodiment can give the same effects as the first embodiment through configurations common to both embodiments.

While the present embodiment is a modified example based on the first embodiment, the present embodiment can be combined with the second embodiment or the fourth embodiment.

### Other Embodiments

(1) In the first embodiment, as illustrated in FIG. 8, the first STC 51 and the second STC 52 are different from each other, and the relationship between the lapse time T and the first threshold value Ap1 and the relationship between the lapse time T and the second threshold value Ap2 are different from each other. However, this is one example. It is considered that one of the two different relationships still has different factors but the other has two factors that are not different.

(2) In the first embodiment, in step S061 of FIG. 4, the determination processing section 253 transmits, to the communication bus 3a, an amplitude feature Apc from the post-correction amplitude A1a of the first incoming signal S1r, but need not send all the amplitude features Apc of the post-correction amplitude A1a to the communication bus 3a. For example, at least an amplitude feature Apc, which is higher than or equal to the first threshold value Ap1, from among all the amplitude features Apc of the post-correction amplitude A1a is to be transmitted to the communication bus 3a, while an amplitude feature Apc lower than the first threshold value Ap1 does not have to be transmitted to the communication bus 3a.

The same applies to the processing contents of steps S062 to S06n. Step S062 is described as an example. In step S062, at least an amplitude feature Apc, which is higher than or equal to the second threshold value Ap2, from among all the amplitude features Apc from the post-correction amplitude A2a of the second incoming signal S2r is to be transmitted to the communication bus 3a, while an amplitude feature Apc lower than the second threshold value Ap2 does not have to be transmitted to the communication bus 3a.

(3) In the embodiments, the plurality of transducers 21 in FIG. 1 transmit the search waves Sw with transmission timings shifted from each other. However, this is one example. For example, the plurality of transducers 21 are acceptable even if simultaneously transmitting the search waves Sw without shifted transmission timings as long as the plurality of incoming signals originating from different transmission sources can be distinguished according to the transmission sources thereof. When the plurality of transducers 21 simultaneously transmit the search waves Sw, the STCs used in steps S051 to S05n of FIG. 4 need not be differentiated from each other.

(4) In the embodiments, as illustrated in FIG. 3, the detection determination section 254 is included in the incoming signal processor 25. However, the detection determination section 254 is acceptable even if included in the controller 3, for example, in the detection result acquisition section 33 within the controller 3 but not in the incoming signal processor 25.

(5) In the fourth embodiment, as illustrated in FIG. 16, the reflected-wave threshold value Apx gives a different value based on the lapse time T. However, the reflected-wave threshold value Apx is acceptable even if giving a value that does not vary based on the lapse time T.

(6) In the embodiments, the first threshold value Ap1 and the second threshold value Ap2 illustrated in FIG. 8 are acceptable even if set so as to be shifted in the direction of increasing or decreasing the amplitude Ap on the vertical axis in FIG. 8. This is because each of the transducers 21 receives reflected waves having different intensities caused by the difference of whether the transmission source of the search wave Sw, based on which the reflected wave has been produced, is the transducer 21 itself or another transducer 21.

(7) In the embodiments, as illustrated in, for example, FIG. 5, the predetermined moment “lapse time T=0” is regarded as the moment when, among the plurality of transducers 21 with shifted transmission timings, the transducer 21 that first transmits the search wave Sw has started the transmission of the search wave Sw. However, this is one example. The predetermined moment can be any moment as long as it is a fixed moment.

(8) In the first embodiment, as illustrated in, for example, FIG. 12, the non-identification point is set to “0”. However, this is one example. The non-identification point is acceptable even if set to, for example, “0.5” as long as the non-identification point is a point lower than the detection point but higher than the non-detection point.

(9) In the embodiments, the object detection device 1 is vehicle-mounted, that is, mounted in a vehicle, but is not limited to this use. That is, for example, the object detection device 1 can be mounted in a vessel or a flight vehicle.

(10) The transducers 21 are not limited to each include a single transmission-and-reception-capable ultrasonic transducer. For example, the transducer 21 is acceptable even if configured to include an ultrasonic transducer for transmission electrically connected to the transmission circuit 22, and an ultrasonic transducer for reception electrically connected to the reception circuit 23.

(11) The configurations of the ultrasonic sensor 2 and the controller 3 are not limited to the specific examples described in the embodiments. That is, for example, the digital/analog conversion circuit may be provided in the drive signal generator 24 instead of the transmission circuit 22. Further, the drive signal generator 24 may be provided in the controller 3.

(12) The encoding method is not limited to the chirp-based encoding. That is, for example, the encoding may be based on phase modulation or on-off modulation.

(13) In the first embodiment, as illustrated in FIG. 1, all the plurality of ultrasonic sensors 2 included in the object detection device 1 have a transmission function of transmitting the search wave Sw that is an ultrasonic wave, and a reception function of receiving the incoming wave Rw. However, this is one example. Some of the plurality of ultrasonic sensors 2 included in the object detection device 1 can have only one of the function of transmitting an ultrasonic wave and the reception function but not the other function.

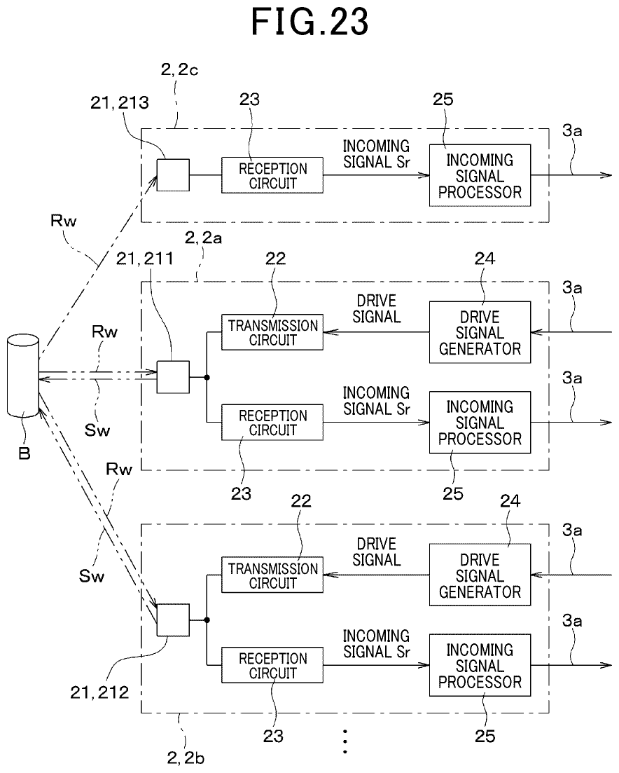

For example, FIG. 23 illustrates an example in which a plurality of ultrasonic sensors 2 included in an object detection device 1 include a third ultrasonic sensor 2c having a reception function but not a function of transmitting an ultrasonic wave. The third ultrasonic sensor 2c is only for receiving an ultrasonic wave, and therefore includes a reception circuit 23 and an incoming signal processor 25 involving the reception of an ultrasonic sensor, but does not include a transmission circuit 22 and a drive signal generator 24 involving the transmission of an ultrasonic wave. In addition, a third transducer 213 as a transducer 21 included in the third ultrasonic sensor 2c is a reception-capable transducer but not a transmission-capable transducer. For example, the third transducer 213 receives, as incoming waves Rw, reflected waves generated by reflection of search waves Sw transmitted from other transducers 21 having a transmission function, such as a first and second transducers 211, 212.

(14) The present disclosure is not limited to these embodiments, and can be carried out with various modifications. In addition, the embodiments are not unrelated with each other but can be combined as appropriate except for combinations that are apparently impossible.

In addition, needless to say, the elements constituting these embodiments are not always essential in the embodiments except for, for example, the cases in which the elements are particularly mentioned to be essential and the cases in which the elements are considered to be clearly essential in principle. Even when the embodiments refer to the numbers of constituent elements of the embodiments, the numerical values, the amounts, and the numerical values of ranges and the like, those referred to are not limited to the numbers specified therein except for, for example, the cases in which those referred to are particularly mentioned to be essential and the cases in which those referred to are in principle clearly limited to the numbers specified. Further, even when the embodiments refer to the material, the shape, the positional relationship, and the like of the constituent elements and the like, those referred to are not limited to the material, the shape, the positional relationship, and the like except for, for example, the cases in which those referred to are particularly mentioned and the cases in which those referred to are, in principle, limited to the material, the shape, the positional relationship, and the like specified.

In the embodiments, various control processors including microcomputers, such as the controller 3, the drive signal generator 24, and the incoming signal processor 25, are described. The control processors and the methods thereof may be implemented by dedicated computers provided so as to include a processor, which has been programmed to execute one or a plurality of functions embodied by a computer program, and a memory. Alternatively, the control processors and the methods thereof may be implemented by dedicated computers provided so as to include a processor formed of one or more dedicated hardware logic circuits. Alternatively, the control processors and the methods thereof may be implemented by one or more dedicated computers configured to include a combination of a processor, which has been programmed to execute one or a plurality of functions, and a memory, with a processor formed of one or more hardware logic circuits. As an instruction to be executed by a computer, the computer program may be stored in a computer-readable non-transitory tangible memory medium.

What is claimed is:

1. An object detection device that detects a surrounding object,
the object detection device comprising: a plurality of transducers that include a first transducer and a second transducer each transmitting a search wave that is an ultrasonic wave distinguishable from one another; and
an incoming signal processor, wherein
at least any one of the plurality of transducers including the first transducer and the second transducer is a reception-capable transducer that receives a reflected wave produced by reflection of the search wave from the object, and
from a reflected-wave signal corresponding to the reflected wave received by the reception-capable transducer, the incoming signal processor distinguishes a first incoming signal corresponding to a reflected wave of the search wave transmitted by the first transducer and a second incoming signal corresponding to a reflected wave of the search wave transmitted by the second transducer, and performs first signal processing, which is signal processing for the first incoming signal, under a prescribed first condition and performs second signal processing, which is signal processing for the second incoming signal, under a prescribed second condition different from the first condition.

2. The object detection device according to claim 1, wherein
the incoming signal processor is communicably connected to a communication pathway, and transmits, to the communication pathway, processing results of the first signal processing and the second signal processing, and a feature of the first incoming signal and a feature of the second incoming signal.

3. The object detection device according to claim 1, wherein
the incoming signal processor extracts, from the reflected-wave signal, an amplitude feature that is a feature of an amplitude of the reflected-wave signal, and performs the first signal processing and the second signal processing using the amplitude feature.

4. The object detection device according to claim 1, wherein
the incoming signal processor extracts, from a signal representing an amplitude of the reflected-wave signal, a portion, in which a local maximum of the amplitude of the reflected-wave signal exceeds a prescribed reflected-wave threshold value, as an amplitude feature, and performs the first signal processing and the second signal processing using the amplitude feature.

5. The object detection device according to claim 4, wherein
the second transducer transmits the search wave after a lapse of a predetermined delay time from a moment when the first transducer has transmitted the search wave, and
the reflected-wave threshold value is changed based on the delay time.

6. The object detection device according to claim 4, comprising an external-environment sensing section that senses an external environment affecting the amplitude of the reflected-wave signal, wherein
the reflected-wave threshold value is changed based on the external environment sensed by the external-environment sensing section.

7. The object detection device according to claim 1, wherein
the incoming signal processor,
in the first signal processing, corrects the first incoming signal by a first STC, and determines whether a post-correction amplitude of the first incoming signal obtained through the correction by the first STC is higher or equal to a prescribed first threshold value; and
in the second signal processing, corrects the second incoming signal by a second STC, and determines whether a post-correction amplitude of the second incoming signal obtained through the correction by the second STC is higher than or equal to a prescribed second threshold value, and
the difference between the first condition and the second condition is at least either one of a difference between a relationship between a lapse time and the first threshold value determined based on the lapse time and a relationship between a lapse time and the second threshold value determined based on the lapse time, or a difference between a relationship between the lapse time and a gain of the first STC and a relationship between the lapse time and a gain of the second STC.

8. The object detection device according to claim 7, wherein
the second transducer transmits the search wave after a lapse of a predetermined delay time from a moment when the first transducer has transmitted the search wave, and
the second threshold value is changed based on the delay time.

9. The object detection device according to claim 7, wherein
the second transducer transmits the search wave after a lapse of a predetermined delay time from a moment when the first transducer has transmitted the search wave, and
the relationship between the lapse time and the second threshold value is increasingly shifted in a direction of increasing the lapse time, along with an increase of the delay time, with respect to the relationship between the lapse time and the first threshold value.

10. The object detection device according to claim 7, wherein
the second transducer transmits the search wave after a lapse of a predetermined delay time from a moment when the first transducer has transmitted the search wave, and
the relationship between the lapse time and the gain of the second STC is increasingly shifted in a direction of increasing the lapse time, along with an increase of the delay time, with respect to the relationship between the lapse time and the gain of the first STC.

11. The object detection device according to claim 7, comprising an external-environment sensing section that senses an external environment affecting an amplitude of the reflected-wave signal, wherein
the first threshold value and the second threshold value are changed based on the external environment sensed by the external-environment sensing section.

12. The object detection device according to claim 7, comprising a detection determination section, wherein
transmission/reception processing including transmission of the search wave by the first transducer and the second transducer and reception of the reflected wave by the reception-capable transducer is repeated over time,
the incoming signal processor performs the first signal processing and the second signal processing when having being able to distinguish the first incoming signal and the second incoming signal from the reflected-wave signal, and
the detection determination section
accumulates a prescribed detection point as a point to be accumulated when the post-correction amplitude of the first incoming signal has been determined to be higher than or equal to the first threshold value in the first signal processing;
accumulates, as the point to be accumulated, a prescribed non-detection point lower than the detection point when the post-correction amplitude of the first incoming signal has been determined to be lower than the first threshold value in the first signal processing;
in a case in which the first incoming signal and the second incoming signal have not been able to be distinguished from the reflected-wave signal, accumulates, as the point to be accumulated, a prescribed non-identification point lower than the detection point but higher than the non-detection point when a post-correction amplitude of the reflected-wave signal obtained through correction by a prescribed non-identification STC has been determined to be higher than or equal to a prescribed non-identification threshold value; and
determines that the object has been detected in the first signal processing when a total number of points obtained by summing the points to be accumulated that have been accumulated over a prescribed number of two or more receptions having consecutively occurred most lately over time is higher than or equal to a prescribed total value for determination.
